(19) United States
(12) Patent Application Publication
(10) Pub. No.: US 2024/0355311 A1
(43) Pub. Date: Oct. 24, 2024

(54) DECOMPOSITION AND SYNTHESIZATION OF MUSIC AND SOUND

(71) Applicant: Kocree, Inc., Champaign, IL (US)

(72) Inventors: Haizi Yu, Champaign, IL (US); Lav Raj Varshney, Champaign, IL (US)

(73) Assignee: Kocree, Inc., Champaign, IL (US)

(21) Appl. No.: 18/584,882

(22) Filed: Feb. 22, 2024

Related U.S. Application Data
(60) Provisional application No. 63/447,593, filed on Feb. 22, 2023.

(51) Int. Cl. G10H 7/08

(52) U.S. Cl. CPC G10H 7/08

(57) ABSTRACT

Particular embodiments described herein provide for an electronic device that includes a system to help enable the decomposition and synthesization of music and sound. In some examples, the system can analyze a sound to identify an encoding of partial information of the sound in order to generate a resultant to be used in creating one or more manipulations associated with the sound, where the partial information is partial abstract data exclusive of sampling and corresponds to one or more patterns of the sound.

### CROSS-REFERENCE TO RELATED APPLICATIONS

This disclosure relates to Provisional Application No. 63/447,593, entitled “DECOMPOSITION AND SYNTHESIZATION OF MUSIC AND SOUND” filed in the United States Patent Office on Feb. 22, 2023, which is hereby incorporated by reference in its entirety.

### TECHNICAL FIELD

This disclosure relates in general to the field of music, and more particularly, to a system for enabling the decomposition and synthesization of music and sound.

### BACKGROUND

Music is generally understood as a collection of coordinated sound or sounds. Accordingly, making music refers to the process of putting sound or sounds in an order, often combining them to create a unified composition. Music creation is commonly divided into musical performance, production, arranging, and composition, along which the level of originality in generating new music content increases.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a system to enable the decomposition and synthesization of music and sound, in accordance with an embodiment of the present disclosure;

FIG. 2 is a simplified block diagram of a portion of a system to enable the decomposition and synthesization of music and sound, in accordance with an embodiment of the present disclosure;

FIG. 3 is a simplified block diagram of a portion of a system to enable the decomposition and synthesization of music and sound, in accordance with an embodiment of the present disclosure;

FIG. 4 is a simplified block diagram of a portion of a system to enable the decomposition and synthesization of music and sound, in accordance with an embodiment of the present disclosure;

FIGS. 5A and 5B are simplified block diagrams of a portion of a system to enable the decomposition and synthesization of music and sound, in accordance with an embodiment of the present disclosure;

FIG. 6 is a simplified block diagram of a portion of a system to enable the decomposition and synthesization of music and sound, in accordance with an embodiment of the present disclosure;

FIGS. 7A and 7B are simplified block diagrams of a portion of a system to enable the decomposition and synthesization of music and sound, in accordance with an embodiment of the present disclosure;

FIG. 8 is a simplified block diagram of a portion of a system to enable the decomposition and synthesization of music and sound, in accordance with an embodiment of the present disclosure;

FIG. 9 is a simplified block diagram of a portion of a system to enable the decomposition and synthesization of music and sound, in accordance with an embodiment of the present disclosure;

FIG. 10 is a simplified block diagram of a portion of a system to enable the decomposition and synthesization of music and sound, in accordance with an embodiment of the present disclosure;

FIG. 11 is a simplified block diagram of a portion of a system to enable the decomposition and synthesization of music and sound, in accordance with an embodiment of the present disclosure;

FIG. 12 is a simplified block diagram of a portion of a system to enable the decomposition and synthesization of music and sound, in accordance with an embodiment of the present disclosure;

FIG. 13 is a simplified block diagram of a portion of a system to enable the decomposition and synthesization of music and sound, in accordance with an embodiment of the present disclosure;

FIG. 14 is a simplified block diagram of a portion of a system to enable the decomposition and synthesization of music and sound, in accordance with an embodiment of the present disclosure;

FIG. 15 is a simplified block diagram of a portion of a system to enable the decomposition and synthesization of music and sound, in accordance with an embodiment of the present disclosure;

FIG. 16 is a simplified block diagram of a portion of a system to enable the decomposition and synthesization of music and sound, in accordance with an embodiment of the present disclosure;

FIG. 17 is a simplified block diagram of a portion of a system to enable the decomposition and synthesization of music and sound, in accordance with an embodiment of the present disclosure;

FIG. 18 is a simplified block diagram of a portion of a system to enable the decomposition and synthesization of music and sound, in accordance with an embodiment of the present disclosure;

FIG. 19 is a simplified block diagram of a portion of a system to enable the decomposition and synthesization of music and sound, in accordance with an embodiment of the present disclosure;

FIG. 20 is a simplified block diagram of a portion of a system to enable the decomposition and synthesization of music and sound, in accordance with an embodiment of the present disclosure;

FIG. 21 is a simplified block diagram of a portion of a system to enable the decomposition and synthesization of music and sound, in accordance with an embodiment of the present disclosure;

FIG. 22 is a simplified block diagram of a portion of a system to enable the decomposition and synthesization of music and sound, in accordance with an embodiment of the present disclosure;

FIG. 23 is a simplified block diagram of a portion of a system to enable the decomposition and synthesization of music and sound, in accordance with an embodiment of the present disclosure;

FIG. 24 is a simplified block diagram of a portion of a system to enable the decomposition and synthesization of music and sound, in accordance with an embodiment of the present disclosure;

FIG. 25 is a simplified block diagram of a portion of a system to enable the decomposition and synthesization of music and sound, in accordance with an embodiment of the present disclosure;

FIG. 26 is a simplified flowchart illustrating potential operations that may be associated with the system in accordance with an embodiment of the present disclosure;

FIG. 27 is a simplified flowchart illustrating potential operations that may be associated with the system in accordance with an embodiment of the present disclosure;

FIG. 28 is a simplified block diagram of a portion of a system to enable the decomposition and synthesization of music and sound, in accordance with an embodiment of the present disclosure;

FIG. 29 is a simplified block diagram of a portion of a system to enable the decomposition and synthesization of music and sound, in accordance with an embodiment of the present disclosure;

FIG. 30 is a simplified block diagram of a portion of a system to enable the decomposition and synthesization of music and sound, in accordance with an embodiment of the present disclosure;

FIG. 31 is a simplified block diagram of a portion of a system to enable the decomposition and synthesization of music and sound, in accordance with an embodiment of the present disclosure;

FIG. 32 is a simplified block diagram of a portion of a system to enable the decomposition and synthesization of music and sound, in accordance with an embodiment of the present disclosure;

FIG. 33 is a simplified block diagram of a portion of a system to enable the decomposition and synthesization of music and sound, in accordance with an embodiment of the present disclosure;

FIG. 34 is a simplified block diagram of a portion of a system to enable the decomposition and synthesization of music and sound, in accordance with an embodiment of the present disclosure;

FIG. 35 is a simplified block diagram of a portion of a system to enable the decomposition and synthesization of music and sound, in accordance with an embodiment of the present disclosure;

FIG. 36 is a simplified block diagram of a portion of a system to enable the decomposition and synthesization of music and sound, in accordance with an embodiment of the present disclosure;

FIG. 37 is a simplified block diagram of a portion of a system to enable the decomposition and synthesization of music and sound, in accordance with an embodiment of the present disclosure;

FIG. 38 is a simplified block diagram of a portion of a system to enable the decomposition and synthesization of music and sound, in accordance with an embodiment of the present disclosure;

FIG. 39 is a simplified block diagram of a portion of a system to enable the decomposition and synthesization of music and sound, in accordance with an embodiment of the present disclosure;

FIG. 40 is a simplified block diagram of a portion of a system to enable the decomposition and synthesization of music and sound, in accordance with an embodiment of the present disclosure;

FIG. 41 is a simplified block diagram of a portion of a system to enable the decomposition and synthesization of music and sound, in accordance with an embodiment of the present disclosure;

FIG. 42 is a simplified block diagram of a portion of a system to enable the decomposition and synthesization of music and sound, in accordance with an embodiment of the present disclosure;

FIG. 43 is a simplified block diagram of a portion of a system to enable the decomposition and synthesization of music and sound, in accordance with an embodiment of the present disclosure;

FIG. 44 is a simplified block diagram of a portion of a system to enable the decomposition and synthesization of music and sound, in accordance with an embodiment of the present disclosure;

FIG. 45 is a simplified block diagram of a portion of a system to enable the decomposition and synthesization of music and sound, in accordance with an embodiment of the present disclosure;

FIG. 46 is a block diagram illustrating an example computing system that is arranged in a point-to-point configuration in accordance with an embodiment of the present disclosure;

FIG. 47 is a simplified block diagram associated with an example ARM ecosystem system on chip (SOC) of the present disclosure;

FIG. 48 is a block diagram illustrating an example processor core in accordance with an embodiment; and

FIGS. 49-59 are illustrated examples of a system to enable the decomposition and synthesization of music and sound, in accordance with an embodiment of the present disclosure.

The FIGURES of the drawings are not necessarily drawn to scale, as their dimensions can be varied considerably without departing from the scope of the present disclosure.

### DETAILED DESCRIPTION

The following detailed description sets forth examples of apparatuses, methods, and systems relating to enabling the abstract decomposition and reassembly of music and sound, in accordance with an embodiment of the present disclosure.

The term “source” includes any music or sound. The term “music” includes all possible formats of music in various represented or annotated forms (e.g., printed sheet music, music notations, musical sounds, etc.). For example, the term “music” includes sheet music and other representations of music. The term “resultant” includes any part abstracted from a source (including the whole part of the source). As opposed to a direct sampling of a segment or track from a source, a resultant can capture an abstract essence of a source (e.g., the underlying harmonic progression, or any stylistic pattern). Despite the fact that a resultant can represent an abstraction of a source, a resultant can be visualized, listened to, edited, and even used as another source. As used in this application, the term “resultant” and the term “muon” mean the same thing and the terms are used interchangeably.

Muons (i.e., resultants) are obtained from hierarchical decompositions of a music/sound source as its decomposed components, sub-components, sub-sub-components, . . . . Every muon encodes certain partial information contained in the original source. The partial information includes a certain higher-level concept that represents some abstract essence of the original music/sound sources, such as an underlying harmonic progression, or a rhythmic or any stylistic pattern. In some examples, the partial information includes a certain sampling of the original music/sound sources, such as one (1) instrument track or the first five (5) seconds of a song. In some examples, the partial information is partial abstract data exclusive of sampling, voice to text, and/or metadata and corresponds to one or more patterns of the sound.

In some examples, muons form hierarchies based on “information inclusion” (which is a partial order). For example, given two muons “A” and “B”, the “A” muon is a sub-component of the “B” muon or the “B” muon is a super-component of the “A” muon if all information in the “A” muon is contained in the “B” muon. Muons are visualizable, audible, editable, manipulable, and programmable (manipulable via algorithmic means). Also, muons are systematically organized in human-interpretable structures such as information lattices. This means, given any muon, not only itself but also its relations to other muons are human-interpretable.

The term “muon mosaic” (or “mosaic”) includes any music or sound obtained by combining one or more muons with other muons, one or more sources, or some other sound or sounds. As described in more detail below, like muons, a mosaic includes an abstract fusion of one or more muons with other muons, one or more sources, or some other sound or sounds, often beyond a direct, arithmetic sum. A mosaic can also be visualized, listened to, edited, and even used as another source. Further, the muon mosaic (or “mosaic”) is the hierarchical synthesization of muons into new music/sound which can happen at abstract levels (e.g., inheriting rhythmic, harmonic, and structural features) that are often beyond a simple arithmetic sum such as simply concatenating or layering audio tracks.

The term “cut” refers to an operation that decomposes a source into a muon. The term “glue” refers to an operation that synthesizes muons into a mosaic. Both cut and glue can operate at abstract levels. A muon database can include the infrastructure that holds the above music/sound abstractions and abstraction hierarchies and the services that allow fast operations on the infrastructure, including but not limited to regular database operations and queries, as well as structural augmentation/updates, caching, search, and AI services such as (machine) training/learning, inference, generation, and analysis. In some examples, a muon-similarity-based search engine can be further integrated into a ranking system, a recommendation system, an advertising system, and other similar type systems.

Note that all the music references herein are intended as examples only and other pieces or types of music may be used. Also, where applicable, the music referenced herein is intended to represent an authorized licensed copy of the music (note that music that is in the public domain does not require a copyright license). The application is not intended to support unlicensed use of music, unauthorized use of music, or illegal user activity related to the music.

In the following description, various aspects of the illustrative implementations will be described using terms commonly employed by those skilled in the art to convey the substance of their work to others skilled in the art. However, it will be apparent to those skilled in the art that the embodiments disclosed herein may be practiced with only some of the described aspects. For purposes of explanation, specific numbers, materials, and configurations are set forth in order to provide a thorough understanding of the illustrative implementations. However, it will be apparent to one skilled in the art that the embodiments disclosed herein may be practiced without the specific details. In other instances, well-known features are omitted or simplified in order not to obscure the illustrative implementations.

In the following detailed description, reference is made to the accompanying drawings that form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). Reference to “one embodiment” or “an embodiment” in the present disclosure means that a particular feature, structure, or characteristic described in connection with the embodiment is included in at least one embodiment. The appearances of the phrase “in one embodiment” or “in an embodiment” are not necessarily all referring to the same embodiment. The appearances of the phrase “for example,” “in an example,” or “in some examples” are not necessarily all referring to the same example. The term “about” includes a plus or minus fifteen percent (±15%) variation.

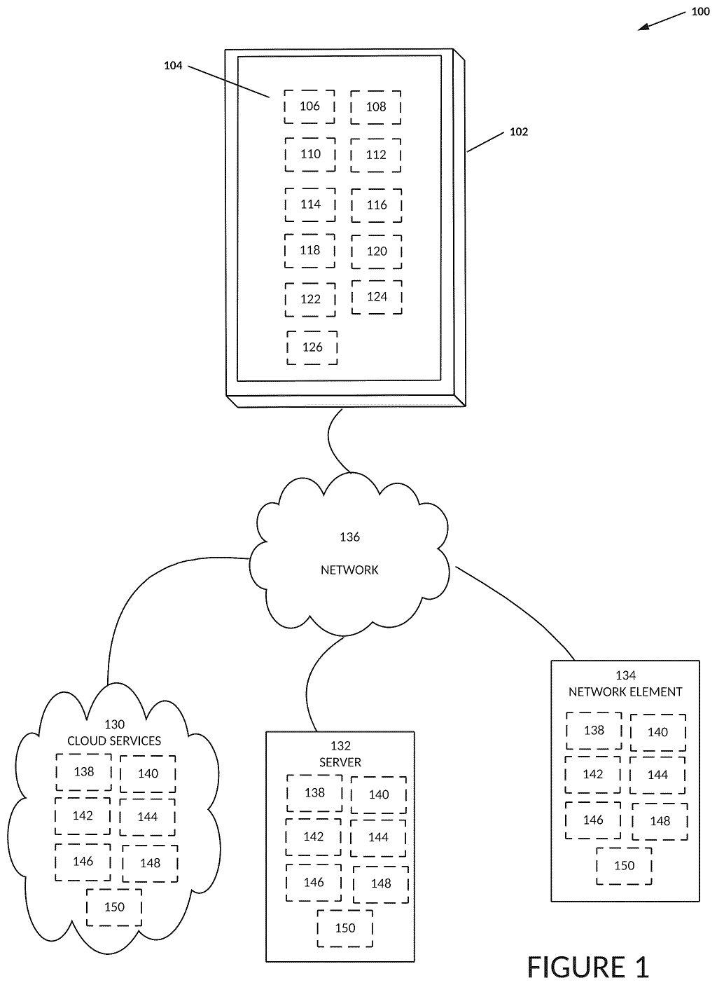

FIG. 1 is a simplified block diagram of a system 100 configured to enable the decomposition and synthesization of music and sound, in accordance with an embodiment of the present disclosure. In an illustrative example, the system can use a computational abstraction framework such as Information Lattice Learning or some other means to produce or create a collection of information lattices and sublattices encompassing learned abstraction patterns for the purpose of creating muons and mosaics. These learned lattices are human-interpretable, corresponding to various types of muon abstractions as well as their hierarchies that help users understand the underlying mechanism used for abstraction, such as invariance properties under various types of symmetries. Associated with the learned lattices are two operators called project and lifting, where the former can be used to cut a source into various muons (decomposition) and the latter can be used to glue muons into a mosaic (synthesis). Both operators operate at abstract levels, as opposed to literal split and sum.

Different types of cuts result in different types of muons. Some of the muon types correspond to known music abstractions/concepts such as melody, harmony, and rhythm; while others refer to unknown or unnamed music abstractions/concepts such as those behaving like “harmony derivatives,” which is not seen yet in existing music theory or terminology but which may be characteristic for certain musical styles and/or may suggest a new style that no one has tried before. The system pretrains several information lattices together with their corresponding project and lifting operators (for cuts and glues), yielding several predefined and commonly used muon types in the system. Intended for users with different musical backgrounds, the system starts from muon types that could be generally understood by the general population such as melody, (basic-level) harmony, rhythm, instrument, but also includes muon types intended for more professional users such as arpeggiation, form, (more advanced) harmony, texture. The system also allows users to define their own customized muon type such as “harmony derivatives”.

Notably, all cuts and glues can be done either by hand (called a human cut/glue) or by algorithm (called an AI cut/glue). All cuts and glues can be further fine-tuned or even created from scratch by hand by experienced users, through a system-provided intelligent co-editing interface, or any other third-party editing tools or software.

Unlike other music information systems that leverage meta-data or other music AI systems that fully automate the entire music creation process, the system presented in this disclosure allows users to zoom into the music content itself and manipulate all kinds of music/sound components freely and intuitively. The system lowers the bar for the general population to perform music co-creation-focusing on music creation at a high/intuitive level—and hence to enjoy the brand-new music co-creation experience created by the system that can be fun and rewarding (e.g., co-creating music in the context of playing a music social game among both music lovers and gamers). In addition, the system can help create a vibrant and inclusive co-creation community where cutters, gluers and all other music lovers and gamers, including without limitation, music curators, dreamers, performers, taste makers, both competitive and collaborative players are intimately interacting with each other in creating and curating all kinds of music, audio, and sound. In an example, the muon can be used as a building block in a gaming system or a composition system, where the muon can be altered or combined with other muons. In some examples, the system can identify a sound such as music, analyze the identified sound to identify one or more muons, and extract the identified one or more muons to be stored for playback, cutting, gluing and/or other types of creating, curating, and/or manipulation of the muon. For example, the one or more muons can be used as a building block to be integrated into other sounds. In some examples, the muon can be used as an emoji for use on a phone, messenger application, text application, etc. where the muon based emoji is a visual representation of music styles, tastes, expression, characteristic, etc., based on a collection of one or more muons.

In an example, an electronic device 102 can include a display 104, memory 106, one or more processors 108, speakers 110, a communication engine 112, a display engine 114, a decomposition and synthesization engine 116, a muon database 118, a source database 120, a mosaic database 122, a user database 124, and a cache database 126. In some examples, the electronic device 102 also includes a microphone. The electronic device 102 can be in communication with cloud services 130, a server 132, and/or one or more network elements 134 using a network 136. One or more of the cloud services 130, the server 132, and/or the network element 134 can include a network decomposition and synthesization engine 138, a network muon database 140, a network source database 142, a network mosaic database 144, a network user database 146, a network cache database 148, and a network AI-model database 150. In some examples, the electronic device 102 does not necessarily include the decomposition and synthesization engine 116, the muon database 118, the source database 120, the mosaic database 122, the user database 124, and instead uses the network decomposition and synthesization engine 138, the network muon database 140, the network source database 142, the network mosaic database 144, and the network user database 146. Network AI-model database 150 can include pretrained AI models such as pretrained lattices, neural networks, etc., which can be used by the system to perform services such as cut, glue, recommendation, search, and other functions and/or AI services.

The display 104 can display an image, an animation, a video, or any other visual content to a user and may be any of a variety of types of display devices, including without limitation, an LCD display, a plasma display, an LED display, an OLED display, a projector, etc. The display engine 114 can be located on a system on chip (SoC) and be configured to help display an image, an animation, a video, or any other visual content on the display 104. The display engine 114 is responsible for transforming mathematical equations and algorithms into individual pixels and frames and corrects for color and brightness, controls the refresh rate, controls power savings of the display 104, touch (if enabled), etc. In some examples, the display 104 can include a timing controller (TCON) (not referenced). The display engine 114 can communicate the individual pixels and frames to the TCON as a video stream with a frame rate. The TCON receives the individual frames generated by the display engine 114, corrects for color and brightness, controls the refresh rate, controls power savings of the display 104, touch (if enabled), etc.

The speakers 110 can produce audio output that can be heard by a listener. More specifically, the speakers 110 can be transducers that convert electromagnetic waves into sound waves. The speakers 110 receive audio input in either an analog or a digital form. Analog speakers simply amplify the analog electromagnetic waves into sound waves. Since sound waves are produced in analog form, digital speakers must first convert the digital input to an analog signal, then generate the sound waves. The sound produced by the speakers 110 is defined by frequency and amplitude. The fundamental frequency determines how high or low the pitch of the sound is. For example, a soprano singer's voice typically produces higher frequency sound waves, while a bass guitar or cello typically generates sounds in a lower frequency range. The communication engine 112 can help facilitate communications, wired or wireless, between the electronic device 102 and the network 136. For example, the communication engine 112 can help facilitate uploading one or more muons, one or more sources, one or more mosaics, or any other content, music, or sound.

The decomposition and synthesization engine 116 and the network decomposition and synthesization engine 138 can help enable the decomposition and synthesization of music and sound, as well as all other auxiliary and assistive services (including without limitation, computing similarities, rankings, recommendations, and also enabling fast search, caching, and storage). The muon database 118 and the network muon database 140 can include different types of muons including system predefined muon types (e.g., melody muons, harmony muons, instrument muons, rhythm muons, etc.) as well as user defined muon types. The source database 120 and the network source database 142 can include one or more pieces of music and/or sound uploaded and/or produced by the system and/or users. The mosaic database 122 and the network mosaic database 144 can include one or more mosaics uploaded and/or produced by the system and/or users. The user database 124 and the network user database 146 can include data related to a user's personal information including without limitation identity, credentials, personal settings, and profile information, as well as information about a user's electronic device 102. The cache database 126 and the network cache database 148 can include data caches that allow fast retrieval of frequently requested content and/or data such as muons, mosaics, pre-trained models, or other frequently requested content and/or data.

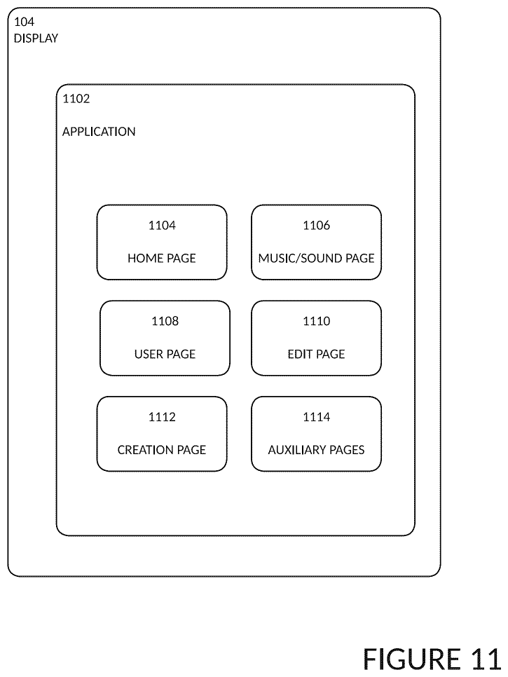

In an illustrated example of a user using the system, the user logs onto the system (e.g., system 100) using an electronic device (e.g., electronic device 102) and accesses a home page (e.g., the home page 1104 illustrated in FIG. 11) of an application (e.g., the application 1102 in FIG. 11). The application can further allow the user to access a music/sound page (e.g., the music/sound page 1106 illustrated in FIG. 11), a user page (e.g., the user page 1108 illustrated in FIG. 11), an edit page (e.g., the edit page 1110 illustrated in FIG. 11), and a creation page (e.g., the creation page 1112 illustrated in FIG. 11). It should be noted that the application can also allow the user to access other pages such as a setting page, a logout page, other auxiliary pages, etc.

The home page allows a user to explore and curate music/sound (e.g., muons, mosaics, sources) as well as explore and curate other users and/or music/sound (e.g., muons, mosaics, sources) associated with the other users. On the home page, music/sound on the system can be explored and curated in various ways (e.g., by categories, genres, artists, timestamps, popularities, qualities such as top rated, most used, best sales, etc.). A user can explore various types of social networking on the home page. Examples include but are not limited to curation-based social networking, creation-based social networking, career-based social networking, interest/taste-based social networking, market-based social networking, education-based social networking, businesses-based social networking, finance-based social networking, as well as sandbox, and/or world-building music games with social scoring. In some examples, the muon can be used as a building block in a gaming system or a composition system, where the muon can be altered or combined with other muons.

The music/sound page is a page of a specific piece of music or sound (e.g., a source or a mosaic). In some examples, the music/sound page can display a source's or a mosaic's basic information (e.g., title, description, authors), social information (e.g., likes, shares, reposts), and a source's or a mosaic's muon components. All music and sound (including sources, muons, mosaics) on the music/sound page can be directly played and heard from speakers (e.g., speakers 110). In some examples, a visualization or visual representation of the selected source/mosaic or any of its muon components can be displayed on the display. In some specific examples, the visualization is a precise representation of the music content (e.g., a visual representation of the sheet music). In an illustrative example, from the music/sound page, the user can start listening to and visualizing the selected source/mosaic. In addition, from the music/sound page, the user can listen to and visualize any existing muon component of the selected source/mosaic, as well as attach new muons to a selected source/mosaic.

Any muon can be selected and used as if it were a keyword (called a “keymuon”) to do search. The keymuon is a type of search key. The system's search engine 804 includes its distinguishing muon-based search service which can search for other muons (e.g., from the network muon database 140) that are similar to the selected “keymuon” as well as other sources/mosaics (e.g., from the network source database 142 and network mosaic database 144) wherein the similar muons are found. For example, the user can select a specific melody muon as the “keymuon”. The system's search engine can then return other similar melodies as well as music containing those similar melodies. Given a specific keymuon, the system can produce a ranking of all other muons in the system, from most similar ones to least similar ones. This muon-based ranking system can be further made into a recommendation system. The kind of recommendations that the system is able to produce includes without limitation similar or contrasting muons (e.g., similar or contrasting melodies, harmonies, and rhythms) as well as similar or contrasting music and sound containing similar or contrasting muons (e.g., a similar song with a similar melody, or a very different song but with the same harmony). All music and sound (including sources, muons, mosaics) found by the search engine can be directly played on the music/sound page and/or heard from speakers (e.g., speakers 110), as well as compared with other music or sound (including sources, muons, mosaics). In some examples, the search engine 804 is further used to build a ranking system, a recommendation system, an advertising system, or an intellectual property tracing system related to the resultant. It should be noted that the music/sound page can also allow the user to access other pages such as a setting page, a logout page, other auxiliary pages, etc.

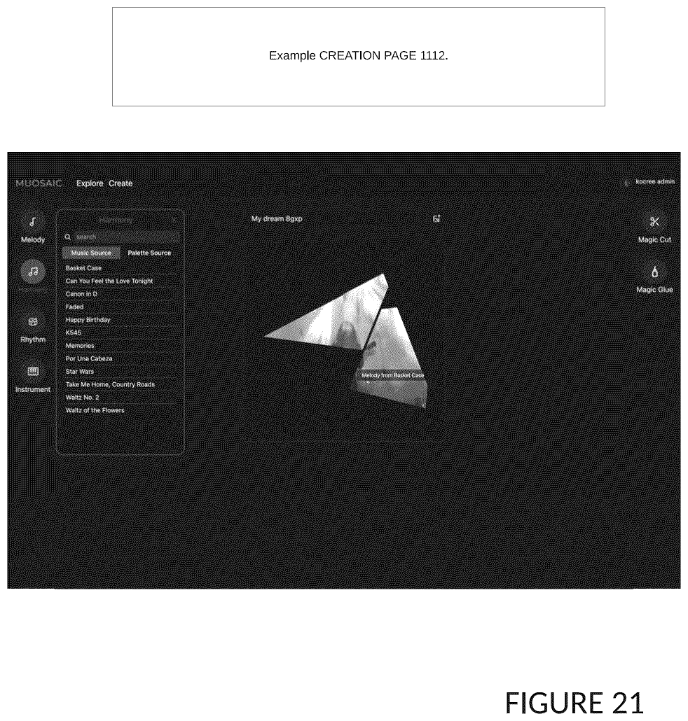

The creation page allows a user to create muons and mosaics. In an illustrative example, a user can create a conceptual muon combo for a mosaic. A conceptual muon can be described by a name tuple: (muon type, source). For example, the tuple (melody, Song A) names a conceptual muon which is a melody muon from Song A. In an illustrative example, the user can drag and drop the desired muon names to a “music canvas” similar to the middle canvas illustrated FIG. 21. For example, the user can select a melody from Song A and a harmony from Song B, by dragging and dropping the two. Notably, the muon-based recommendation systems mentioned in the previous paragraph can be used to help a user explore various muons and muon combos (e.g., recommending muons that tend to fit into each other harmoniously or contrasting muons that may fuse into a surprising result). Next, a user (called a cutter) can cut a desired muon from a desired source. The cut process can be treated as a realization process which realizes a conceptual muon into a muon. For example, the user can cut a melody muon from Song A and a harmony muon from Song B. Then, a user (called a gluer) can glue the desired muon combo into a mosaic. For example, the user can glue the aforementioned melody muon and harmony muon into a mosaic. During a creation process on the creation page, a user can send requests to other users and/or AIs for new sources, muons, mosaics, etc. It should be noted that the creation page can also allow the user to access other pages such as a setting page, a logout page, other auxiliary pages, etc.

The user page allows the user to edit their profile, upload music and/or sound to the source database, as well as manage, share, exchange, and trade sources, muons, and/or mosaic. The user page allows the user to build and manage their social and/or collaborative connections, including without limitation, friends, followers, teams (for music co-creation). On the user page, the user also manages requests/invitations from other users, answers calls for help (e.g., a cut or a glue help) from other users, and joins other teams in accomplishing new music co-creation projects. The user page is also a hub for the user to make and track progress from various projects, as well as a personal repository for the user to maintain uploaded or completed sources, muons, and mosaics. It should be noted that the user page can also allow the user to access other pages such as a setting page, a logout page, other auxiliary pages, etc.

When creating and editing muons or mosaics (e.g., on the creation and music/sound pages), the system provides an online music co-editing interface, which includes human-human, human-AI, and human-AI-human co-editing. More specifically, human-human co-editing includes cases where two or more people synchronously or asynchronously collaborating on making music together. Human-AI co-editing includes AI-aided music creation where a person iteratively interacts with AI (e.g., asking AI for recommendation/inspiration or fine-tuning AI's work) in any aspect of music creation. Human-AI-human co-editing includes AI-aided and AI-coordinated music co-creation where multiple people leverage possibly multiple AIs in any aspect of music co-creation, including without limitation, asking for recommendations related to music creation, team building, and teamwork. It should be noted that the co-editing page can also allow the user to access other pages such as a setting page, a logout page, other auxiliary pages, etc.

When describing music or sound, users, either consciously or unconsciously, typically make abstractions of the music or sound, no matter whether the description is conversational (e.g., “This music is sad and gloomy”) or technical (e.g., “This piece is in the key of f #minor”). The ability to make abstractions and elicit abstracted rules and concepts from raw observations, together with the ability to further make generalizations based on eliciter rules and concepts, makes humans the most intelligent and creative living beings on the earth. The nature of any abstraction, in general, is an equivalence relation where some low-level details are intentionally ignored or forgotten. As a result, distinct objects can be treated equivalently under an equivalence relation. A term directly related to abstraction is called an abstracted concept, or a concept in short. Generally, a concept formed from an abstraction is an equivalence class from the corresponding equivalence relation. The following illustrates an example of an abstraction and an abstracted concept therein. When a person says “This piece of music is in the key of f #minor,” the person is effectively making an abstraction of all pieces of music based on the key such that pieces with the same key pattern (including situations of multiple keys and lacking a key) are all equivalent. That means there is an equivalence relation based on the key where two pieces of music are equivalent if and only if they are in the same key (more precisely, key pattern, including situations of multiple keys and lacking a key). Under this equivalence relation, one can see many equivalence classes, corresponding to many abstract concepts. For example, all f #minor pieces form an equivalence class expressing the concept of “f #minor”; likewise, all C major pieces form another equivalence class expressing the concept of “C major”; other examples of concepts under this equivalence relation follow the same way. If needed, one can label any equivalence class, meaning basically giving it a name, or a term. For example, a label of “f #minor” can be given to the equivalence class of all f #minor pieces. It should be noted that how a concept or an abstraction is named (e.g., whether a concept is named “f #minor” or some other term; whether an abstraction is named “key” or some other term) is not essential but how to define the equivalence relation is. Whenever an equivalence relationship is defined, everything about the corresponding abstraction and its associated concepts are well-defined, no matter whether they have a pre-defined music terminology or not. In the above example of the equivalence relation based on the key, some concepts have a pre-defined name in music such as “f #minor” whereas many other concepts objectively exist that either do not have a commonly agreed upon name or do not have a name at all (e.g., an atonal piece that lacks a clearly perceived key or that includes multiple either clear or ambiguous keys). In those cases, the corresponding concept is still clear and well-defined, but may lack an authoritative name.

Describing a piece of music or sound typically corresponds to the process of making one or more abstractions of the piece. On the other hand, composing a piece of music or sound is the converse of making an abstraction of the piece and is typically called a realization. Generally, a realization is the process of generating a new instance of music or sound that satisfies certain requirements (if any). For example, composing a piece of country music in the key of f #minor is the process of generating a new piece of music that lies in the intersection of two equivalence classes, the equivalence class of all f #minor pieces and the equivalence class of all country music. In some examples, the bi-directional process of abstraction and realization are also respectively seen as music analysis and composition, or music reduction and elaboration. The general idea and formalism of abstraction and realization can be captured by computational abstraction and automatic concept learning frameworks. One example of such frameworks is called Information Lattice Learning.

Information Lattice Learning is a general theory of learning rules from data (the abstraction process) and generating new data based on some given rules (the realization process). Here, a rule can include an abstract pattern (e.g., a pattern distilled from an abstraction, as opposed to a raw pattern from the raw observation). More specifically, Information Lattice Learning is a theory about signal decomposition and synthesis in a human-interpretable way akin to human experiential learning, where high-level rules and concepts (knowledge) are distilled from sensory signals (raw observation) and conversely, rules are applied to generate new signals. Information Lattice Learning itself is also a generalization of Shannon's lattice theory of information. However, in Information Lattice Learning, patterns such as probability measures (used to describe probabilistic and/or statistical patterns) are not given a priori but are learned from training data sets.

A core step in Information Lattice Learning includes mathematical representations of almost any real-world observation and their abstractions. In Information Lattice Learning, the signal domain can be abstracted via all sorts of equivalence relations, where mathematically, every equivalence relation can be defined and represented as a partition of the signal domain. Given a signal domain, there are various multiple ways of partitioning the domain, just like there are various multiple perspectives from which users make abstractions of real-world observations. Multiple partitions of the same signal domain are related, through the so-called coarser-finer relation (a partial-order relation), just like there are coarser or finer or incomparable (in the sense of coarser or finer) abstractions/concepts in music (e.g., f #minor is a special case of minor, f #minor is incomparable with country music since not all country music is in f #minor, nor are all f #minor pieces country). Multiple partitions not only form a partially ordered set (poset) but also form a special type of poset called a lattice, where the notion of a supremum (also called a least upper bound or join) and an infimum (also called a greatest lower bound or meet) are well-defined. This means that not only two music concepts may be related via the partial order as exemplified above, but also concepts such as “country music in f #minor” are well-defined in the mathematical and computational sense. Notably the notion of a join and a meet are also closely related to logical AND (e.g., music that is both country and in f #minor) and logical OR, so they are also well-defined in the logical and computational logical sense

Partition lattices constitute the core formalism in Information Lattice Learning to study various abstractions as well as their hierarchies. Attaching statistical information to partition lattices yields information lattices. Compared to partition lattices, information lattices can be used to further study what is special about certain abstractions (e.g., special abstracted patterns or rules). For example, a data set of f #minor pieces is special from the perspective of the key (they are all in f #minor). On the contrary, a data set of waltz pieces is not so special from the perspective of the key (in this data set, the waltz pieces may appear in all sorts of different keys) but special from the perspective of the rhythm (typically in triple meter like % time). Any statistical pattern on a partition is called a (probabilistic) rule, e.g., a rule saying 90% of the pieces in this waltz data set are in % time.

The system can use Information lattice learning to distill rules from data (e.g., what makes country music country) and to generate new data based on some given rules (e.g., compose a piece in the style of country music). Information Lattice Learning has several of its main applications in domains regarding automatic knowledge discovery. In several illustrative examples, the Information Lattice Learning framework is based on group-theoretic and information-theoretic foundations, which can rediscover the rules of music as known in the canon of music theory and also discover new rules that have remained unexamined and/or those for emerging music styles. Unlike many pattern recognition algorithms, rules discovered by Information Lattice Learning are human-interpretable. Unlike many rule-based AI, Information Lattice Learning does not require human hardcoding rules a priori, but instead, automatically generates human-interpretable rules that are either previously known or unknown to humans.

In addition, Information Lattice Learning excels as a generative model, where it exhibits a higher level of generalization power. In conventional generative models, machine-generated samples follow the learned probability distribution of the training data, such that these models can generate new data that is like the training data. Beyond this level of generalization ability, the system can use Information Lattice Learning to further generate new data distributions (not just new data) that are different from training data distribution but agree with the training distribution on several probabilistic rules. For example, this allows the system to generate new pieces of music that sound like Bach in certain desired ways (rhythmic, harmonic, etc.) whereas at the same time stay as far away as possible from all Bach's existing pieces.

The above two abilities boil down to two algorithmic operators operated in the opposite directions along information lattices, namely the project and the lifting operators. The former projects raw data down along information lattices to seek potential rules about the data. The latter lifts rules up to the top of information lattices to produce new data satisfying the desired rules. The two operators form the back engine that drives the system's cut functions and glue functions.

The general goal of Information Lattice Learning is that, given raw signals from/of datasets (e.g., music corpora), rule sets are created to summarize the given raw signals. Note the definition here of a rule (likewise, a concept, an abstraction) follows the precise mathematical definition in Information Lattice Learning. This definition is not exactly the same as but is closely related to our common notions of a “rule” (e.g., dictionary definition of a rule used in our everyday conversation). In many examples, desired rule sets are those that are simple and essential. The definitions of simple and essential may vary depending on the applications. In some typical examples, a rule set is considered simpler (than another rule set) if it consists of fewer, lower-entropy rules. Here, a lower-entropy rule means it is more deterministic (as opposed to more random) and closer to our common notions of a “rule” (such that lower-entropy rules really reflect patterns that are frequently or even deterministically recurring, which therefore, are also easier for humans to understand and remember). A rule set is considered more essential (than another rule set) if it can be used to recover the original raw signal better.

To learn desired rule sets, the entire Information Lattice Learning process used by the system comprises two consecutive phases, namely lattice construction and lattice learning. More specifically, the learning process includes both how to construct a lattice-structured abstraction universe that specifies the abstraction and structural possibilities of rules and concepts (Phase 1), as well as how to find desired rules by performing an iterative statistical learning loop through a student-teacher algorithmic architecture (Phase 11).

Typically, the first phase involves constructing partition lattices based on group-theoretic, order-theoretic, and lattice-theoretic foundations with minimal domain-specific priors. The construction is prior efficient, meaning it is interpretable, expressive, systematic, and requires minimal domain knowledge encoding. The need for priors is to ensure not only computational efficiency but also human interpretability as not every partition has a natural, human-interpretable explanation, however, those coming from priors that represent human innate cognition (e.g., from group-theoretic invariances, or generally the so-called Core Knowledge priors developed in cognitive science) are naturally explained by human-interpretable mechanisms (e.g., symmetries represented by group action as defined in mathematics).

Lattice construction plays a role similar to building a function class in machine learning (like building a neural network in deep learning), which is generally considered in the regime of meta-learning. While its importance is commonly understood, the construction phase in many data-driven models is often treated cursorily using basic templates and/or ad hoc priors leaving most computation to the learning phase. In contrast, the system can put substantial computational and mathematical effort into the prior-driven construction phase. Pursuing generality and interpretability, the system can draw universal, simple priors that are domain-agnostic and close to innate human cognition (e.g., the Core Knowledge priors developed in cognitive science which include without limitation, algebraic, geometric, and topological symmetries). Later in the learning phase, the system can then decode more concepts (capturing certain essences of the data), either previously known or unknown, from the information lattice based on their various patterns (e.g., probabilistic and statistical patterns) learned from data. For example, all music written under a particular chord progression obeys several particular symmetries. From the information lattice, the system can learn what exactly that symmetry structure is and then generate new pieces that obey the same or similar symmetries (e.g., yielding new pieces written under the same or similar chord progressions).

In the construction phase, the system can use computational abstraction and computational group theory algorithms to construct abstractions and their hierarchy. To go from mathematically formalized abstractions to computationally explicit abstractions, the system can use two general algorithmic principles—a top-down approach and a bottom-up approach (up and down with respect to a lattice structure)—to generate hierarchical abstractions from hierarchical symmetries enumerated in a systematic way. The top-down approach leverages composition series of groups and various other group decomposition theories, which is particularly good for fine learning of more detailed rules and structures from raw data (e.g., zooming into a particular music style to hierarchically discover its microscopic music-composition structure, as well as how a similar composition-decomposition structure affects different styles of music). The bottom-up approach starts from a set of atomic symmetries and grows into all symmetries that are seeded from the given set. The bottom-up approach is particularly good for customized music rule/style exploration, which typically has a higher chance to discover new rules and new composition possibilities. Constructed partition lattices form the universe of all possible abstractions that are considered in the second phase, the learning phase.

The learning phase of the Information Lattice Learning framework starts with several constructed partition lattices and several data sets that are not necessarily of a large size (e.g., a small number of chorales by J. S. Bach), and then can learn rules from the constructed lattices and data sets. Unlike some current prevalent deep learning technologies that are black-box and data-hungry, Information Lattice Learning is white-box and data-efficient. Here, a “white box” means a transparent and intrinsically human-interpretable model and a model is “data-efficient” if it can efficiently capture the key concepts or essence from very few data samples.

Technically, a typical learning module in an information lattice includes searching for a minimal subset of simple rules from the information lattice of a signal (dataset) to best explain that signal (dataset). The system, like principal component analysis, first finds the most essential rule in explaining the signal, then the second most essential rule in explaining the rest of the signal, and so on. Learning in the lattice proceeds iteratively, according to a “teacher-student” architecture. The “student” is a generative model and the “teacher” is a discriminative model. The two components form a loop where the teacher guides the students step by step toward a target style (e.g., a style exemplified in an input dataset such as Bach's chorales) through iterative feedback and exercise. Here, feedback and exercise map onto the process of extracting and applying rules, respectively. This “teacher-student” learning loop is executed by attempts to optimize information functionals in the two components. For example, the student can try to find the most random (largest entropy) probability distribution so as to be as creative as possible as long as it satisfies the current rule set. On the other hand, the teacher can try to find the most discriminative (largest relative entropy) rule to add to the rule set. The added rules satisfy lattice-structural constraints, are not redundant with existing rules, and typically have highly concentrated probability mass (i.e., low entropy). This iterative procedure is a practical and efficient algorithmic solution to the main goal of searching for a minimal subset of simple rules from the information lattice of a signal so as to best explain that signal.

To walk through the “teacher-student” loop in more detail, the system starts with an empty rule set. Then the teacher (discriminator) takes as input the student's latest style and the input training style (both in terms of probability distributions of the raw signal) and identifies one abstraction, which tries to stay as perpendicular as possible to the previously discovered abstractions while at the same time discloses maximal gap between the two styles (e.g., measured by KL divergence). The identified abstraction in this iteration is then made into a rule and is added to the rule set. Adding this type of rules closes stylistic gaps and tends to better recover the target style. Computationally, this maximization is a discrete optimization problem, which also corresponds to the optimization of a divergence quantity called Bayesian surprise. The student (generator) takes as input the augmented rule set to update its writing style. During this process, the student tries its best to satisfy all the rules in the rule set (resolving conflicts if any) while at the same time, tries to be as creative as possible. Creativity can be measured in many different ways (e.g., maximizing entropy to allow more music composition possibilities, or maximizing KL divergence to yield a piece that maximally differs from the existing ones but in the same style as the existing ones by following similar rules).

In short, the teacher extracts rules while the student applies rules and both perform their tasks by solving optimization problems. The system can output a human-interpretable hierarchy of human-interpretable rules, where the hierarchy is interpretable due to the lattice structure and the rules are interpretable due to their mechanistic explanation (e.g., from symmetries). The system is also capable of generating new music snippets as well as sequences of music snippets that gradually transition from one style to another or mix several styles.

It is to be understood that other embodiments may be utilized and structural changes may be made without departing from the scope of the present disclosure. Substantial flexibility is provided by an electronic device in that any suitable arrangements and configuration may be provided without departing from the teachings of the present disclosure.

As used herein, the term “when” may be used to indicate the temporal nature of an event. For example, the phrase “event ‘A’ occurs when event ‘B’ occurs” is to be interpreted to mean that event A may occur before, during, or after the occurrence of event B, but is nonetheless associated with the occurrence of event B. For example, event A occurs when event B occurs if event A occurs in response to the occurrence of event B or in response to a signal indicating that event B has occurred, is occurring, or will occur. Reference to “one embodiment” or “an embodiment” in the present disclosure means that a particular feature, structure, or characteristic described in connection with the embodiment is included in at least one embodiment. The appearances of the phrase “in one embodiment” or “in an embodiment” are not necessarily all referring to the same embodiment.

For purposes of illustrating certain example techniques of the system 100, the following foundational information may be viewed as a basis from which the present disclosure may be properly explained. Music can be described and composed in many different ways. Accordingly, there are several major types of music languages, music representations, and music models that are commonly used today. Unfortunately, the music models that are commonly used today are often not easily adapted for use when describing or composing music algorithmically to reflect a person's music idea or intuition.

More specifically, text-based human language, which can include effusive and subjective statements, is one of the most commonly used models to describe music. For example, “Haydn's Symphony No. 45 (‘farewell’) is a classic example of his Sturm und Drang writing, wherein marvelously inventive and varied music is by turns dramatic and sublime” is a statement that includes effusive and subjective statements. These text-based effusive and subjective statements can be roughly or intuitively understood by laymen. However, the text-based effusive and subjective statements are often vague, ambiguous, subjective, and can have semantic overlap and repetition.

Text-based human language used to describe music can also include technical and clinically objective statements. For example, “The first movement of Haydn's Symphony No. 45, Allegro assai, is in ¾ time and begins on the tonic of f #minor, cast in the sonata form and giving us Sturm und Drang.” These text based technical and clinically objective statements are typically used by professional musicians and can be more precise and objective. However, the text based technical and clinically objective statements can include jargons in specific professional settings (as opposed to a universal language), which can be specific for a particular style, culture, community, or system (e.g., jargons used in Western Music versus those used in World Music).

Using music metadata, sometimes also known as music tags, to describe music is also commonly seen in many music recommendation systems, music search engines, and music information retrieval (MIR techniques). Music metadata often includes the title and verbal description of a piece, the names of the artists (e.g., composers, arrangers, producers, uploaders, publishers), as well as style/genre tags. Music metadata can be used as natural languages/texts algorithmically and hence benefit from many existing natural language processing (NLP) models. However, music metadata does not touch the core music content and is often generated by humans and can be subjective, (e.g., style/genre tags attached to a song).

As a summary for text-based music languages, representations, models, texts are often subjective and non-precise. They are second-hand information (e.g., summarized by a person or an algorithm) instead of intrinsic, literal information about the music itself. Accordingly, algorithmic systems (e.g., recommendation systems, search engines, and MIR techniques) built on text-based languages, representations, and models essentially treat music as text. These systems often heavily rely on tedious and inconsistent human labor in creating music text and/or tags, and therefore are subjective, non-precise, and sensitive to human tagging errors and/or misconceptions.

On the other hand, music-based digital languages, representations, and models can be precise and objective in faithfully representing music and sound. This type of music languages, representations, and models can further be divided into two large categories: audio-based and notation-based. Examples of the former include digital audio workstations (DAWs) such as Ableton and Logic Pro, as well as audio-based music AI systems, which are typically and widely used among audio/sound engineers, music producers, etc. Examples of the latter include notation software such as MuseScore, Dorico and Finale as well as symbolic music AI systems, which are typically and widely used among composer, arrangers, song writers, classical performers, etc. The music-based digital languages, representation, and models enable direct manipulations of music and sound, which precisely and objectively reflects the manipulated music and sound itself.

However, existing music-based creation and editing tools (e.g., DAWs and notation software) can be too low-level and hence hard for the general public to use. They typically have very steep learning curves and do not intuitively and directly translate into our intuition, imagination, and perception of music and sound.

Existing music-based AI systems are often hard for people to understand and interact with effectively. In a large majority of circumstances today, the way people interact with music AI systems is actually to interact with the music (end result) produced by the AI systems instead of interacting with the AI system itself. For most users, “interacting” with those AI systems boils down to just listening to a few AI-generated pieces and saying “like” (keep) or “dislike” (pass). The users are not really involved in the composition process because the user cannot open the AI systems and understand how these systems work. In these cases, the users are basically playing the role as a “filter” instead of a composer. The fundamental reason behind this is that those AI systems are often end-to-end whose behavior can be extremely difficult to understand in a human-interpretable way, and because of this, the majority of the state-of-the-art AI systems are often called “black boxes”.

Generally, people like music, and music is often everywhere in our life. However, for some people, music is “far away” in a sense that the majority of the general population cannot really touch and hence fully sense/appreciate music and sound. Music to most people is like something that they can only perceive as a whole at a distance. Currently, the way of appreciating music for most people is still just listening to music plus sometimes singing the piece they heard (vocal reproduction); fewer people perform music via an instrument (instrumental reproduction); even fewer make new changes, variations, improvisations, arrangements; and even fewer create/compose original music. What is needed is a system, method, apparatus, etc. to help enable the decomposition and synthesization of music and sound.

A system and method to help enable the decomposition and synthesization of music and sound can resolve these issues (and others). In an example, the system is a white box that allows the user to enter the regime of music composition where they can freely drive and steer music in their chosen way, as well as freely discuss, share, and co-create music with peers. The system can help enable systematic and hierarchical music decomposition and re-composition. Compared to a DJ's mixing model that is typically done through slicing and layering tracks at a literal level, the system can be more flexible and creative, including DJ mixing as a special case while at the same time enabling a much larger variety of other possibilities at various abstract levels so as to capture various essences of the intended music and sound.

In the system, any source can be cut (decomposed) into fragments, called muons and in turn, the muons can be glued (reassembled) into a new music or sound. In the system, the two core actions associated with the music decomposition-and-synthesis process are called cut and glue. The former cuts (decomposes) music into music fragments called “muons” and the latter glues (synthesizes) muons into new music or sound.”

Compared to a DJ's mixing model (typically done through slicing and layering tracks), the notion of a track is only one out of many examples of a muon, and the notion of a track is a very restrictive example which is a literal component. Some more examples of generalized components that abstractly capture certain musical essences include without limitation, melodic contour, melodic backbone, (often higher-level) harmony, or rhythm of a piece. Accordingly, slicing and layering tracks are only one (literal, restrictive) out of many examples of cut and glue, respectively. In general, music is not necessarily track-based. Music can be decomposed and synthesized in many flexible ways, whether literal (i.e., in a narrow sense) or abstract (i.e., in a generalized sense). In the system, music can be decomposed and reassembled in many other different ways. In some sense, a DJ does not really create new music but rather, new music rendering. In contrast to the DJ's mixing model, the system allows new music composition, yielding fundamentally new pieces of music.

The examples below, are examples of literal musical components (such as tracks), literal decomposition (such as DJ slicing and sampling), literal synthesis (such as DJ mixing) as well as their abstract/generalized counterparts (muons, cut, and glue). As shown below, sheet music can be used to illustrate some of the concepts discussed herein. Note that all music examples in this disclosure are for illustrative purposes only. These examples may or may not lead to pieces that are musical, or musically pleasant in whatever sense.

Consider a (slightly modified) excerpt from the Piano Sonata No. 16 in C major (K 545) by Wolfgang Amadeus Mozart, as an example of a music source illustrated in FIG. X0.

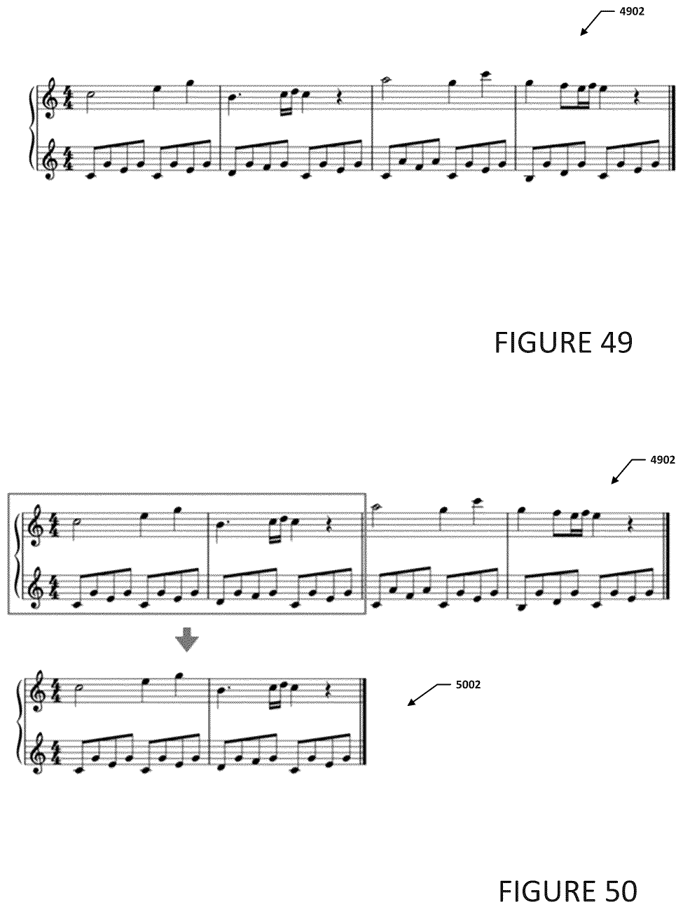

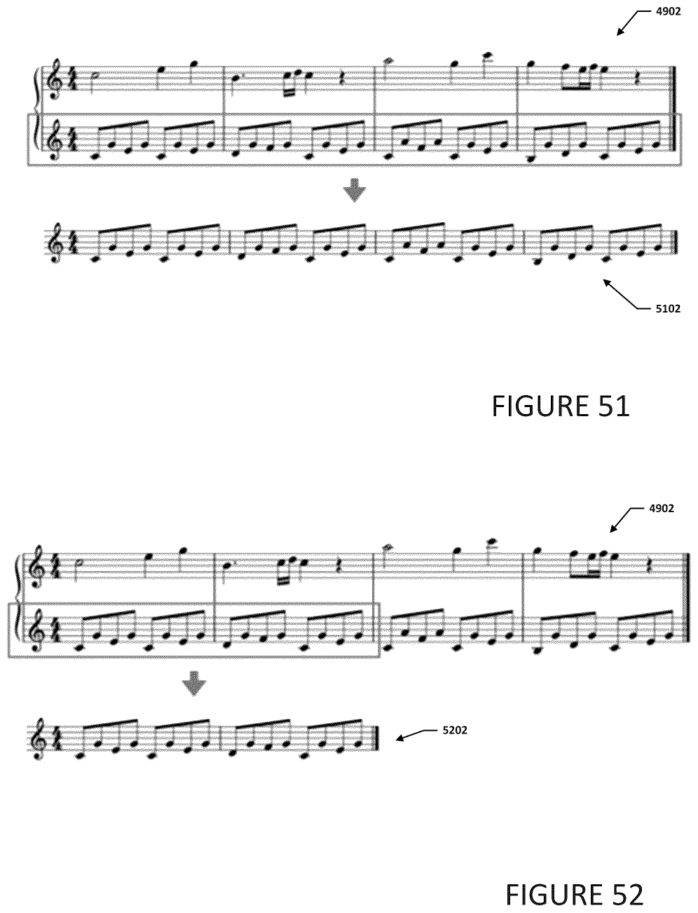

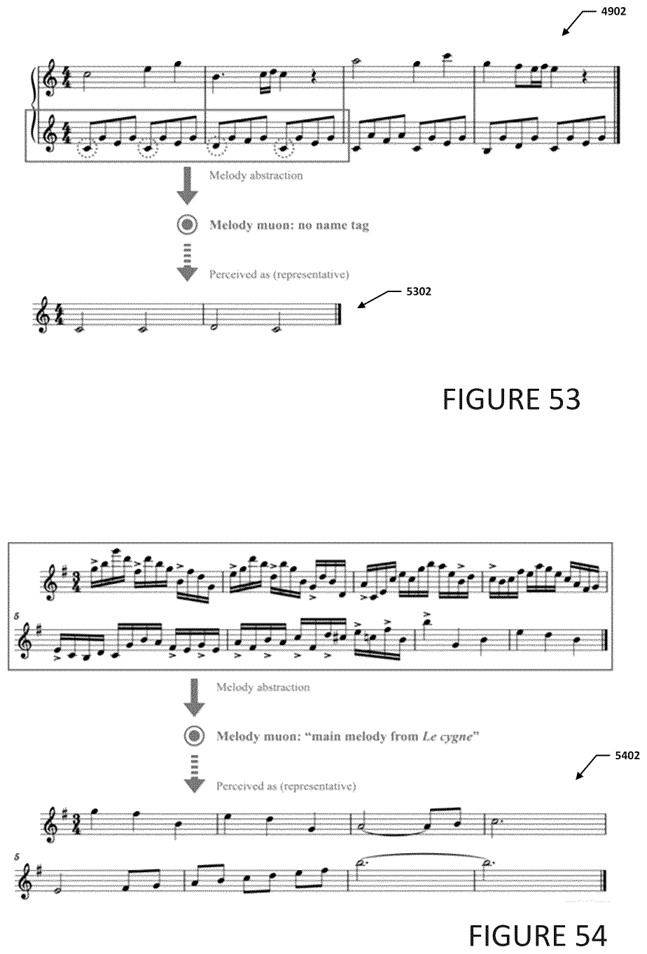

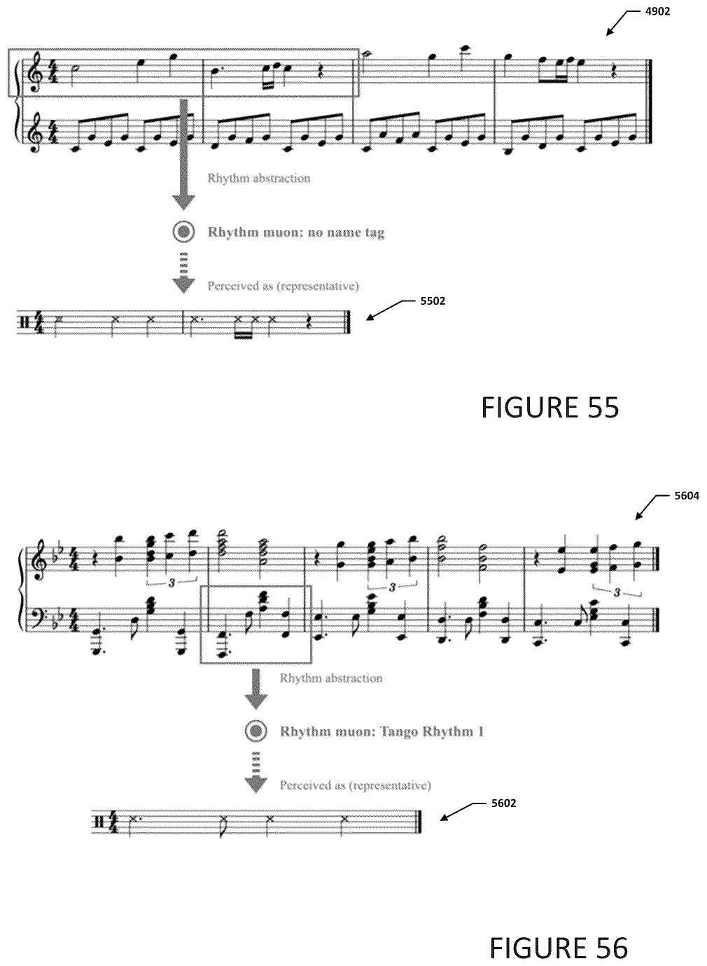

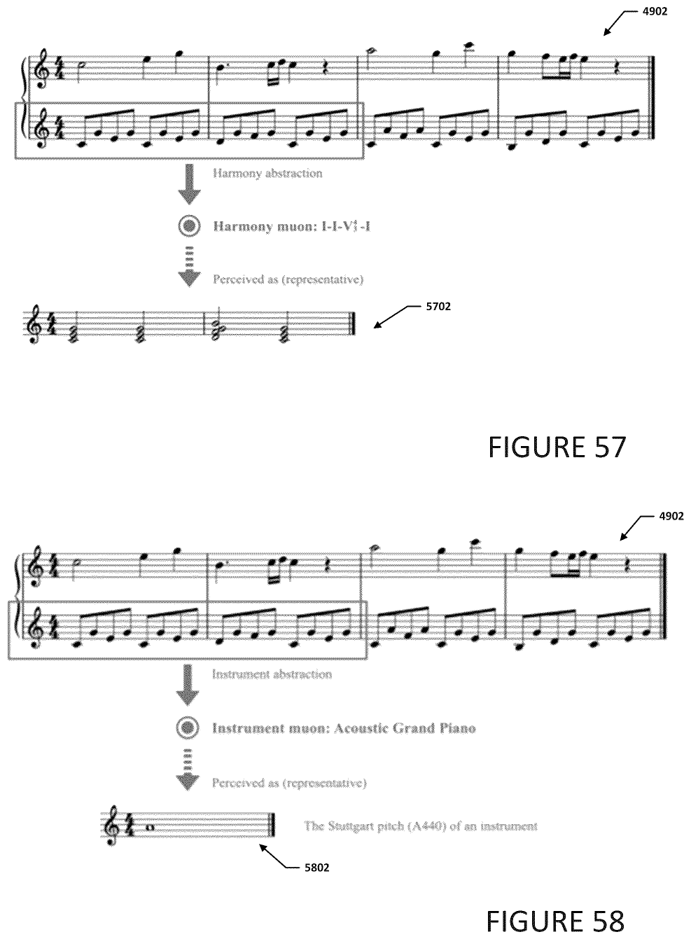

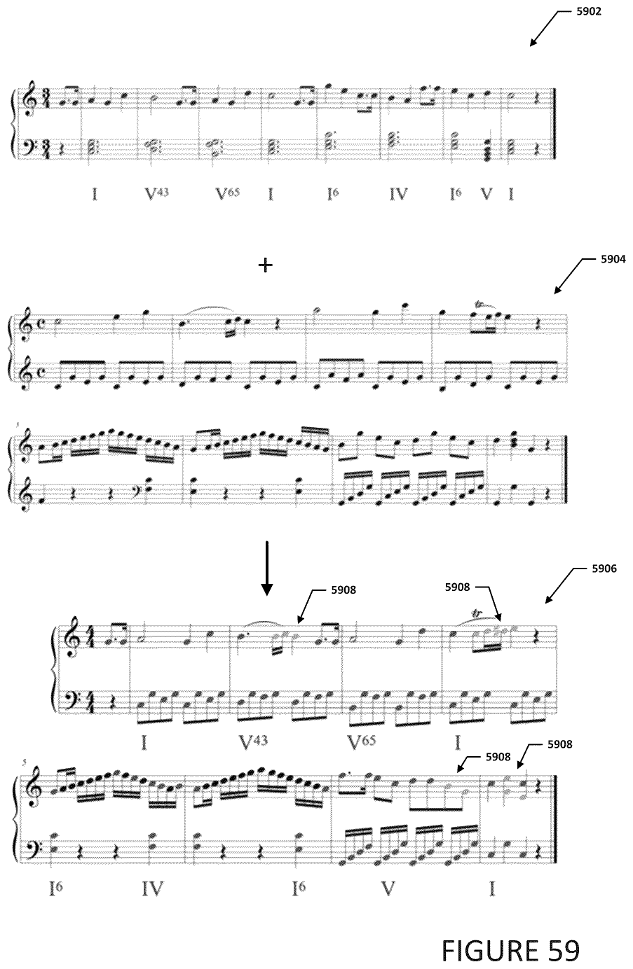

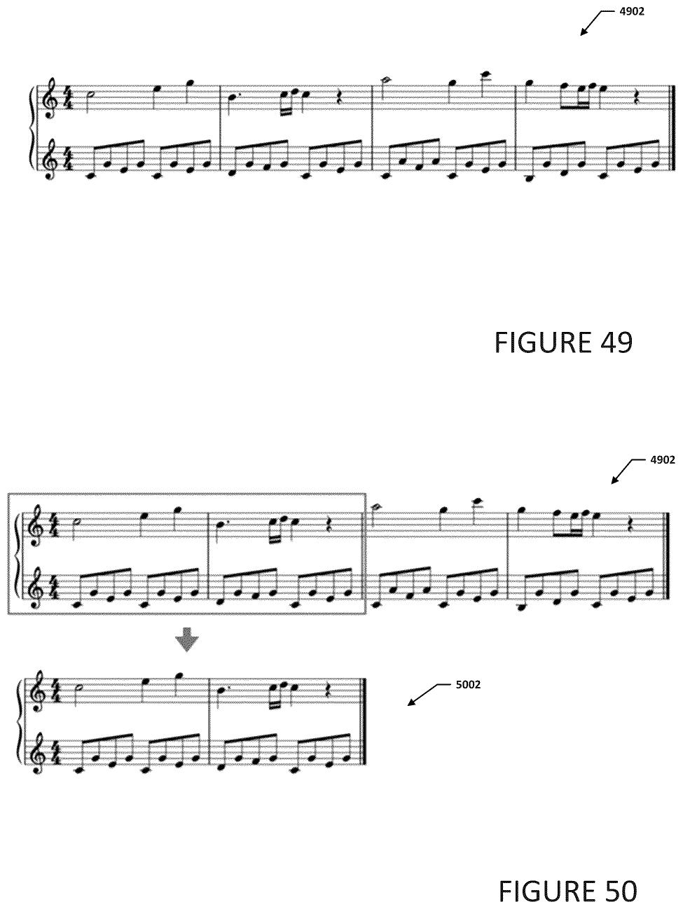

FIG. 49: a modified excerpt from Mozart's K545 4902.

As what a DJ would typically do, a literal cut refers to a literal sampling from a source (sometimes with minor or non-essential modifications such as changing tempo or key), resulting in a literal muon. Examples of literal cut and literal muon (like DJ-style sampling and the notion of a track) are presented in FIGS. X1-X3.

FIG. 50: Example 1 of literal cut and literal muon 5002: sampling a few bars from the modified excerpt from Mozart's K545 4902 (time slicking).

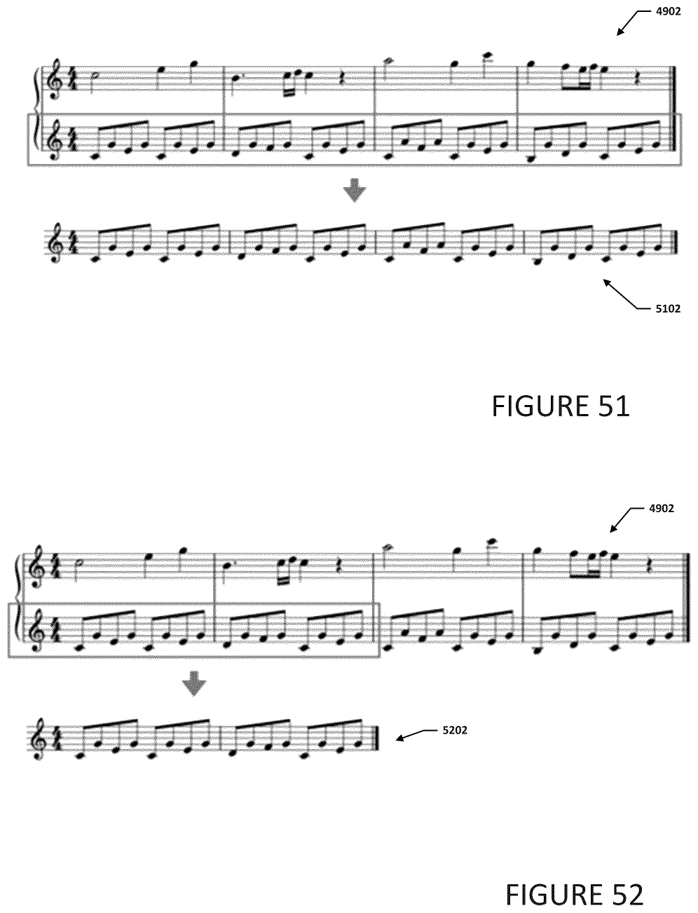

FIG. 51: Example 2 of literal cut and literal muon 5102: sampling a track from the modified excerpt from Mozart's K545 4902 (track slicing).

FIG. 52: Example 3 of literal cut and literal muon 5202: sampling a few bars from a sampled track from the modified excerpt from Mozart's K545 4902 (both time and track slicing).

In contrast with literal cuts and literal muons, music can be cut in more abstract ways, yielding more abstract muons. Some commonly seen music concepts that are related to more abstract muons include, but are not limited to, melody (and melody backbone), harmony (at different levels), rhythm, texture, instrument. Literally sampling a track, or part of a track, could be considered as a faithful extraction of a melody from a source. However, melodies can be extracted in various more abstract ways, such as “melody backbones” through melodic reduction (FIG. X4). Some of the abstract cuts and abstract muons are widely known in our existing music knowledge and often have their already commonly adopted terminologies, such as melody, harmony, rhythm. However, in the system, muon types, as different ways of music abstractions, can be from an existing named category (e.g., harmony), an existing unnamed category (a known music concept without a commonly agreed upon name/terminology), or a newly created/customized category.

More specifically, when describing a piece of music, a person typically makes abstractions of the heard music, either consciously or subconsciously, no matter whether the description is conversational such as “this is country music” or technical such as “this piece is in f #minor”. The nature of any abstraction in general (not necessarily music abstractions) is an equivalence relation. By the mathematical definition, an equivalence relation is a binary relation that is reflexive, symmetric and transitive. Every equivalence relation bijectively corresponds to a partition of the underlying set into disjoint equivalence classes. Two elements of the given set are equivalent to each other if and only if they belong to the same equivalence class. In other words, through an abstraction, the system will intentionally “forget” some low-level details and treat some distinct objects as if they were the same. For example, considering music abstraction based on genres, all country music is treated equivalently as one equivalence class or considering music abstraction based on keys, all f #minor pieces are not distinguished from each other but are distinguished from pieces in other keys such as c minor or a traditionally unrecognized key or keys (e.g., atonal music).

Any abstraction directly yields, and is represented by, its associated concepts. As the nature of an abstraction is an equivalence relation, the nature of a concept is an equivalence class (under an equivalence relation). For example, when abstracting music based on the key, the concept of “f #minor” refers to an equivalence class that is a set exclusively consisting of all f #minor pieces. Under this key equivalence relation, other parallel concepts can be expected, such as another equivalence class of all c minor pieces as well as equivalence classes that do not currently have a name or a commonly agreed upon name.

While abstractions and concepts are mathematically well-defined (as equivalence relations and equivalence classes, respectively), name tags, labels, or other descriptive texts are commonly used to represent abstractions and concepts. For example, “genre” and “key” are two different name tags for abstractions; under the “key” abstraction, “f #minor” and “c minor” are two different name tags for concepts. Name tags are convenient, if the meaning of the name tag is well understood within a certain community or a certain culture. However, this also reveals several downsides of using name tags. Name tags may not always be 100% accurate or 100% agreeable (e.g., to name a certain genre). Name tags may be drawn from inconsistent naming conventions due to different communities, cultures, etc. New abstractions and new concepts always come and go much more quickly, much more frequently, with much more flexible life cycles, compared to commonly agreed upon names (which often takes a long time to reach a consensus). Naming typically lags behind the rise and fall of new concepts. As a result, instead of using name tags, labels, or any other descriptive texts, a more convenient way is to use the so-called representatives to refer to concepts in abstractions

A representative of a concept is also well defined mathematically as one element from an equivalence class. It is a typical example of a concept used to represent that concept. In many cases, there is a “default” way or ways to pick representatives for a concept. Unlike concept name tags which are descriptive and require some understanding or interpretation based on the text, a representative of a concept itself is an instance that can be perceived directly (e.g., a music representative that can be directly played, listened to, and even visualized in some circumstances).

In the system, cutting a muon from a source corresponds to the process of projecting the source onto a certain music abstraction space and yielding an abstracted concept of the original source. For example, cutting a harmony muon from a song means projecting that song onto some abstraction space (based on a certain harmony equivalence) and yielding a concept such as “I-V-vi-IV”. As a result, the following terminology can be used in the system. A muon type refers to an abstraction or an abstraction space (e.g., “harmony” is a muon type). A muon refers to an abstracted concept. For example, “I-V-vi-IV” denotes a muon of the muon type “harmony” or in short, it denotes a harmony muon. The system allows people to perceive all muons through representatives. Muons may have name tags too if a commonly agreed upon terminology exists (e.g., the roman-numeral tag “I-V-vi-IV” used in music theory). FIGS. X4-X7 illustrate examples of cuts and muons in several more abstract ways.

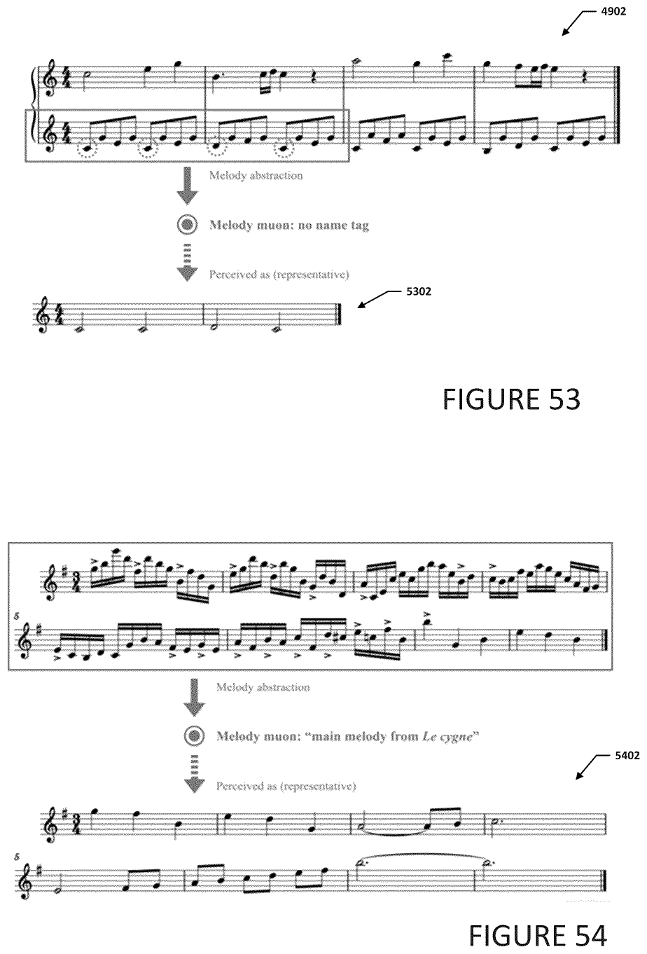

FIGS. 53 and 54: two examples of cutting a melody backbone 5302 and 5402 from the modified excerpt from Mozart's K545 4902. Note: a melody muon may be name tagged if it is from some iconic tune (e.g., vocal part of a popular song). However, this is not always the case, so melody muons may not always have name tags.

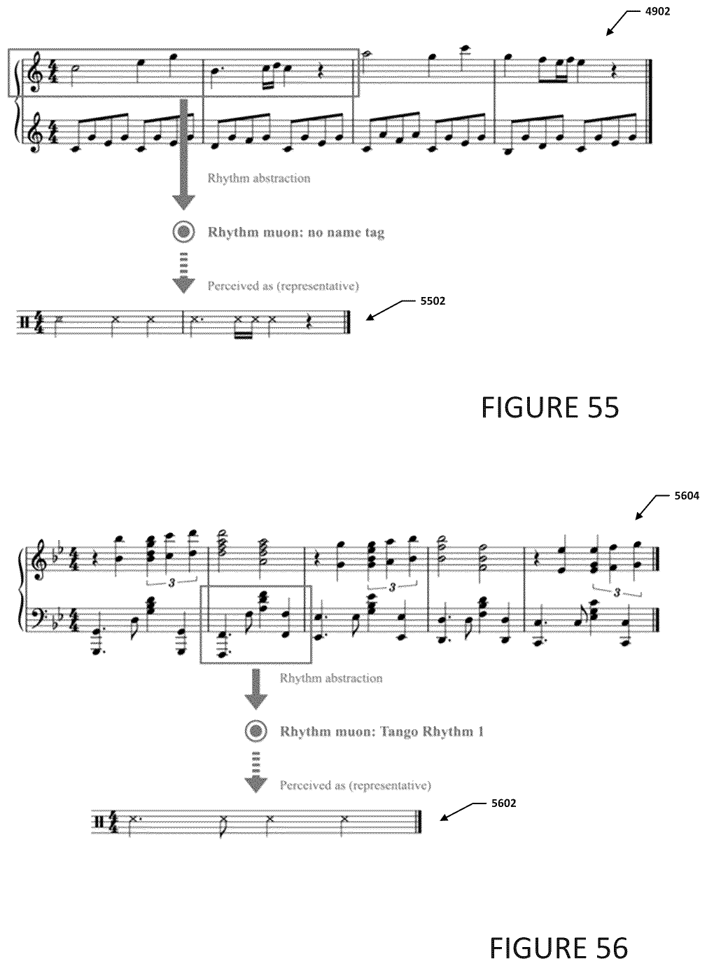

FIGS. 55 and 56: two examples of cutting a rhythm muon. In FIG. 55, a rhythm muon 5502 is cut from the modified excerpt from Mozart's K545 4902. In FIG. 56, a rhythm muon 5602 is cut from a tango 5604. Note: a rhythm muon may be name tagged if it is recognized as a typical dance rhythm (e.g., Tango). However, this is not always the case, so rhythm muons may not always have name tags.

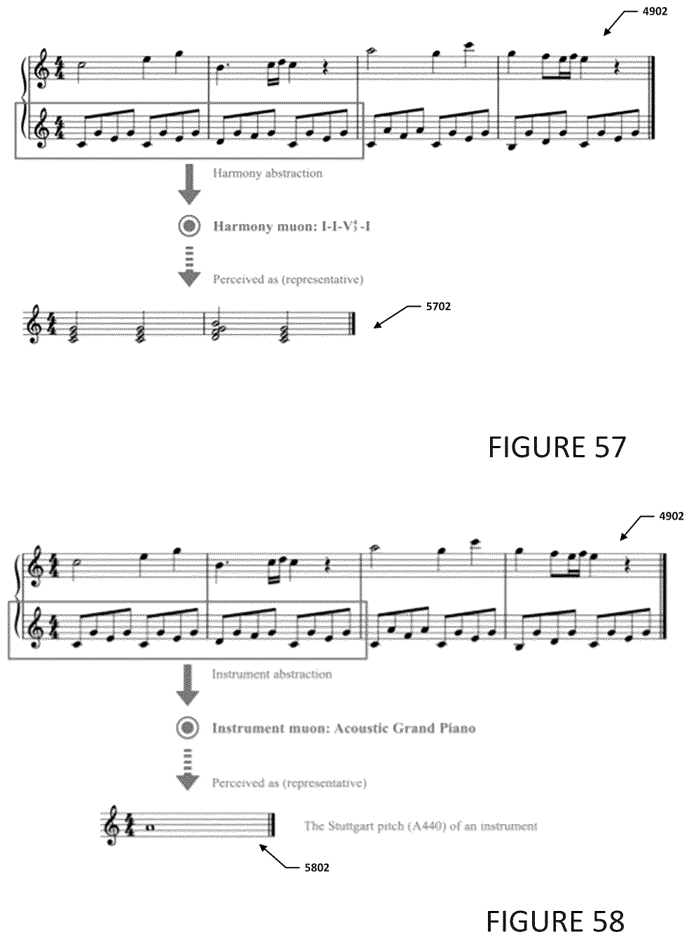

FIG. 57: an example of cutting a harmony muon 5702 from the modified excerpt from Mozart's K545 4902. Note: a harmony muon may lack a concise name tag (e.g., roman-numeral notation, figured-bass notation, or jazz notation), if certain chord(s) cannot be recognized as predefined chords in any existing music theory.

FIG. 58: an example of cutting an instrument muon 5802 from the modified excerpt from Mozart's K545 4902. Note: an instrument muon may have a user-defined or user-customized name tag, if the instrument is not from any well-known music instruments such as piano or violin. For example, a user-made instrument or a user-synthesized sound made by leveraging computer audio technology may have a user-defined or user-customized name tag.

As illustrated by all examples in FIGS. 53-58, any perceived muon representing the abstracted concept is not a literal part from the original source. FIGS. 53-58 illustrate the four main muon types that may be implemented in the system. However, other muon types including but not limited to those commonly recognized as well as user defined and user customized may be used in the system.

In addition to the ability of abstract muon cuts from various music/sound sources, the system is capable of abstract muon glues. As a result, the system can be a music composition model that creates fundamentally new music, which is beyond just music arranging and production. This makes the system in stark contrast with DJ models that typically only make new music renderings instead of fundamentally new music.

To show the differences from DJ mixing that is typically done via literally concatenating and/or layering music samples under certain matching techniques (e.g., linking tracks in beat matching), FIG. X8 illustrates an example of a glue of muons into a mosaic, where the overall glue encompasses various types of glues including literal and abstract ones, as well as combination of these types of glues.

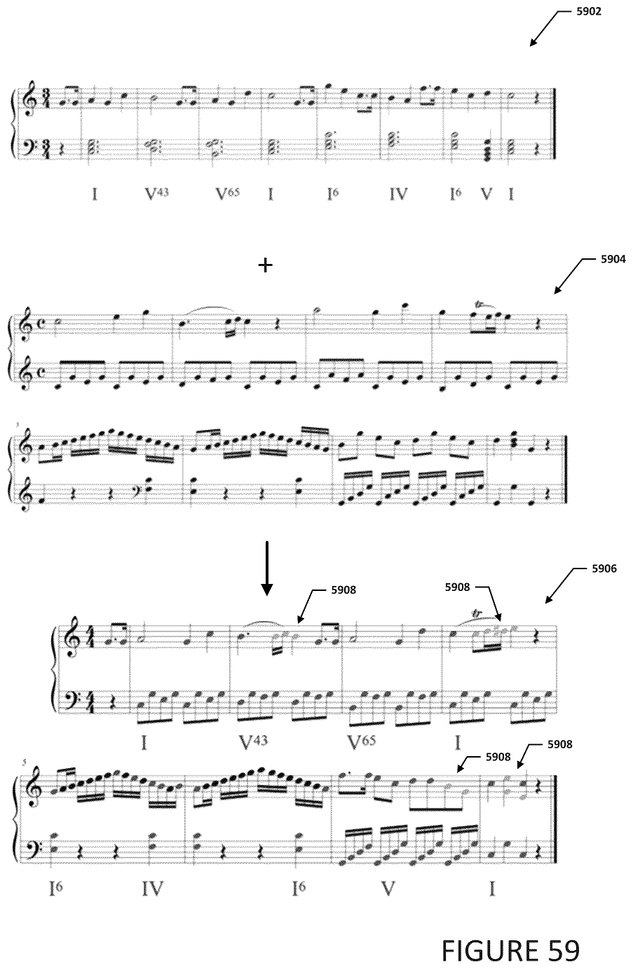

FIG. 59: an example of a mosaic 5906 obtained via a glue of muons cut from two sources, namely the Happy Birthday song 5902 and Mozart's K545 5904. More specifically, in the final mosaic, melody and harmony muons are from the Happy Birthday song 5902; rhythm and texture muons are from the Mozart's K545 5904. New parts 5908 is from neither the Happy Birthday song 5902 nor the Mozart's K545 5904, but new content to bridge the gaps. Part of the melody muon (mm. 5-6) is used as a melody backbone which is further fleshed out in the glue, which demonstrates an abstract glue. Further, integrating just the rhythmic part from the Mozart's K545 5904 is another demonstration of an abstract glue, since none of the music notes (pitches) from the Mozart's K545 5904 is actually used in the final synthesis. The overall glue encompasses all types of glues, whether literal or abstract, as well as any combination of these types of glues.

The abstraction power of the system further allows muon-based music/sound search in various abstract ways and at various abstraction levels. This makes the search much more flexible and much more intelligent than a literal search typically based on “raw matching”.

To illustrate the difference between a literal search and an abstract search in music/sound, a user can first compare a literal search and an abstract search in the context of text-based search. Text-based search is widely seen in apps as the Find command (“Ctrl/Cmd+F”) and in online search engines such as Google™. The search typically starts with a search keyword or keywords and returns content (e.g., sentences, paragraphs, documents, files) containing the keyword(s). A literal search finds an exact or almost exact (e.g., being case insensitive) match at the level of raw strings. Examples include “Ctrl/Cmd+F” and an online search engine search using quotes. A slightly more abstract search may consider, to some extent, the meaning and the contextual information of the keyword(s), and include things like synonyms and/or auto-completions of the keyword(s) in a search result. Examples include an online search engine search without quotes. A more abstract search emerges by leveraging recent NLP (Natural Language Processing) technology, taking more semantic information and prior knowledge into consideration. For example, from a keyword like “banana”, a more abstract search engine may return results that not only contain “banana” or “bananas”, but also other fruits like “pineapple” and “strawberries”, or even “Minions” (more abstract association of concepts).

The system can use a muon-based music/sound search, where a muon (instead of text) is used as an “abstract keyword” (called a “keymuon”) in the music/sound search. For example, the system can initialize a music search using a harmony muon (e.g., a harmony muon “I-V-vi-IV”) as the keymuon and then find music pieces containing that exact same harmony (e.g., “Take me home, country roads”, “Can you feel the love tonight”) as well as pieces containing a similar harmony (e.g., Alan Walker's “Faded” containing “vi-IV-I-V”). When listening to any found music, the system can allow the user to further explore a muon-decomposition of a piece of music currently being played or listened to, pick one or multiple muons that interest the user, and then continue doing muon-based search to find other pieces sharing the same or a similar melody and/or harmony and/or rhythm and/or user-defined or user-customized music abstraction. Repeating the aforementioned process yields the following search sequence: Muon A→Song X (containing A or A′)→Muon B (from X)→Song Y→Muon C→ . . . . The above muon-based music search sequence can further become the backbone of a music recommendation system operated in various abstract ways and at various abstraction levels.

Notably, all types of searches mentioned above, whether literal or abstract, are useful in their own use cases and there is no universal “best” search. While text-based searching does have use cases where precision is key and a literal search is all that is needed, a music search, on the other hand, may not desire such precision all the time. A common complaint about existing music recommendation systems is that they are not very creative in recommending new content, but instead, often recommend nearly the same music again and again. As such, searching music based on more abstract concepts is often more desired. With muon-based music/sound search, recommendation systems can be built that recommend dramatically distinct music pieces, as long as they are associated via certain desired underlying muon abstractions. For example, a search based on abstract concepts can produce melodically very different tango pieces with similar harmonies, or a brand new piece faithfully in the style of Chopin but dramatically different from all existing Chopin's pieces or their literal concatenations/mixtures.

In an example implementation, the electronic device 102 is meant to encompass an electronic device that includes a display, especially a computer, laptop, electronic notebook, hand held device, wearables, network elements that have a display, or any other device, component, element, or object that has a display. Electronic device 102 may include any suitable hardware, software, components, modules, or objects that facilitate the operations thereof, as well as suitable interfaces for receiving, transmitting, and/or otherwise communicating data or information in a network environment. This may be inclusive of appropriate algorithms and communication protocols that allow for the effective exchange of data or information. Electronic device 102 may include virtual elements.

In regards to the internal structure associated with electronic device 102, electronic device 102 can include memory elements (e.g., memory 106) for storing information to be used in the operations outlined herein. Electronic device 102 may keep information in any suitable memory element (e.g., hard disk, hard drive, volatile memory, non-volatile memory, random access memory (RAM), read-only memory (ROM), erasable programmable ROM (EPROM), electrically erasable programmable ROM (EEPROM), application specific integrated circuit (ASIC), etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received in electronic device 102 could be provided in any database, register, queue, table, cache, control list, or other storage structure, all of which can be referenced at any suitable timeframe. Any such storage options may also be included within the broad term ‘memory element’ as used herein.

In certain example implementations, the functions outlined herein may be implemented by logic encoded in one or more tangible media (e.g., embedded logic provided in an ASIC, digital signal processor (DSP) instructions, software (potentially inclusive of object code and source code) to be executed by a processor, or other similar machine, etc.), which may be inclusive of non-transitory computer-readable media. In some of these instances, memory elements can store data used for the operations described herein. This includes the memory elements being able to store software, logic, code, or processor instructions that are executed to carry out the activities described herein.

In an example implementation, elements of electronic devices 102 may include software modules (e.g., login engine 202, listen engine 204, visualization engine 206, creation engine 208, user engine 210, analysis engine 212, etc.) to achieve, or to foster, operations as outlined herein. These modules may be suitably combined in any appropriate manner, which may be based on particular configuration and/or provisioning needs. In example embodiments, such operations may be carried out by hardware, implemented externally to these elements, or included in some other network device to achieve the intended functionality. Furthermore, the modules can be implemented as software, hardware, firmware, or any suitable combination thereof. These elements may also include software (or reciprocating software) that can coordinate with other network elements in order to achieve the operations, as outlined herein.

Additionally, electronic device 102 may include one or more processors that can execute software, logic, or an algorithm to perform activities as discussed herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read-only memory (EPROM), an electrically erasable programmable read-only memory (EEPROM)) or an ASIC that includes digital logic, software, code, electronic instructions, or any suitable combination thereof. Any of the potential processing elements, modules, and machines described herein should be construed as being encompassed within the broad term ‘processor.’

Implementations of the embodiments disclosed herein may be formed or carried out on a substrate, such as a non-semiconductor substrate or a semiconductor substrate. In one implementation, the non-semiconductor substrate may be silicon dioxide, an inter-layer dielectric composed of silicon dioxide, silicon nitride, titanium oxide and other transition metal oxides. Although a few examples of materials from which the non-semiconducting substrate may be formed are described here, any material that may serve as a foundation upon which a non-semiconductor device may be built falls within the spirit and scope of the embodiments disclosed herein.

In another implementation, the semiconductor substrate may be a crystalline substrate formed using a bulk silicon or a silicon-on-insulator substructure. In other implementations, the semiconductor substrate may be formed using alternate materials, which may or may not be combined with silicon, that include but are not limited to germanium, indium antimonide, lead telluride, indium arsenide, indium phosphide, gallium arsenide, indium gallium arsenide, gallium antimonide, or other combinations of group Ill-V or group IV materials. In other examples, the substrate may be a flexible substrate including 2D materials such as graphene and molybdenum disulphide, organic materials such as pentacene, transparent oxides such as indium gallium zinc oxide poly/amorphous (low temperature of dep) Ill-V semiconductors and germanium/silicon, and other non-silicon flexible substrates. Although a few examples of materials from which the substrate may be formed are described here, any material that may serve as a foundation upon which a semiconductor device may be built falls within the spirit and scope of the embodiments disclosed herein.

Electronic device 102 may be a standalone device or in communication with cloud services 130, a server 132 and/or one or more network elements 134 using network 136. Network 136 represents a series of points or nodes of interconnected communication paths for receiving and transmitting packets of information. Network 136 offers a communicative interface between nodes, and may be configured as any local area network (LAN), virtual local area network (VLAN), wide area network (WAN), wireless local area network (WLAN), metropolitan area network (MAN), Intranet, Extranet, virtual private network (VPN), and any other appropriate architecture or system that facilitates communications in a network environment, or any suitable combination thereof, including wired and/or wireless communication.

In network 136, network traffic, which is inclusive of packets, frames, signals, data, etc., can be sent and received according to any suitable communication messaging protocols. Suitable communication messaging protocols can include a multi-layered scheme such as Open Systems Interconnection (OSI) model, or any derivations or variants thereof (e.g., Transmission Control Protocol/Internet Protocol (TCP/IP), user datagram protocol/IP (UDP/IP)). Messages through the network could be made in accordance with various network protocols, (e.g., Ethernet, Infiniband, OmniPath, etc.). Additionally, radio signal communications over a cellular network may also be provided. Suitable interfaces and infrastructure may be provided to enable communication with the cellular network.

The term “packet” as used herein, refers to a unit of data that can be routed between a source node and a destination node on a packet switched network. A packet includes a source network address and a destination network address. These network addresses can be Internet Protocol (IP) addresses in a TCP/IP messaging protocol. The term “data” as used herein, refers to any type of binary, numeric, voice, video, textual, or script data, or any type of source or object code, or any other suitable information in any appropriate format that may be communicated from one point to another in electronic devices and/or networks.

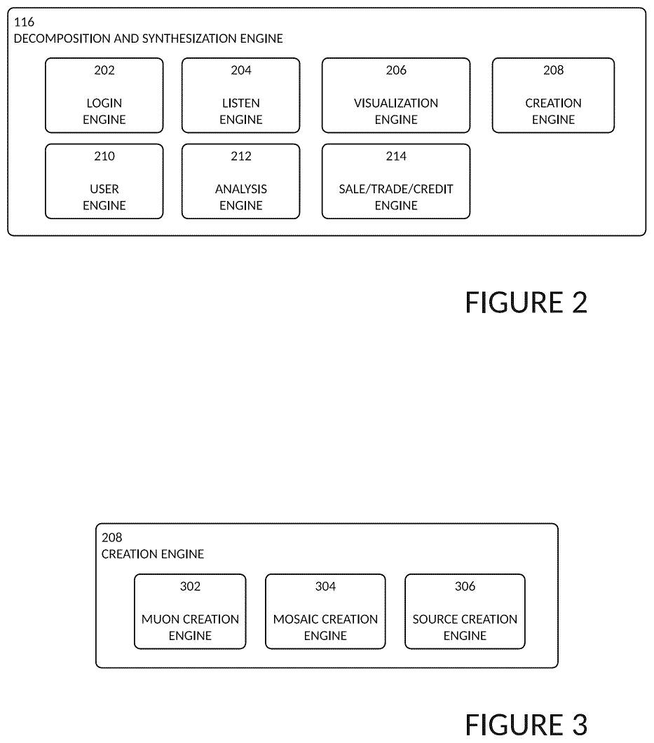

Turning to FIG. 2, FIG. 2 is a simplified block diagram of a portion of a system 100 configured to enable the decomposition and synthesization of music and sound, in accordance with an embodiment of the present disclosure. As illustrated in FIG. 2, the decomposition and synthesization engine 116 can include a login engine 202, a listen engine 204, a visualization engine 206, a creation engine 208, a user engine 210, an analysis engine 212, and a sale/trade/credit engine 214. The decomposition and synthesization engine 116 helps to allow users with diverse music backgrounds to create/curate music and sound (e.g., muons, mosaics, and sources) as well as share/trade their creations/curations with other users.

The login engine 202 is configured to authenticate a user and allow the user to access the system. The login engine 202 can use biometric authentication, alphanumeric authentication, and/or some other type of authentication that can be used to verify the identity of the user. Once the identity of the user is verified, the login engine 202 can allow the user to access the system. In some examples, the system does not include the login engine 202. For example, the system may not require a login or the system may use the electronic device's user authentication system. More specifically, if the user is using the electronic device, the system can determine that the user has already been authenticated by the user device.

The listen engine 204 is configured for users to listen to music and sound (e.g., muons, mosaics, sources). The visualization engine 206 is configured to display a visualization of the music and sound (e.g., muons, mosaics, sources) to the user. In many cases, such a visualization is a precise visual representation of the heard content, and hence can be later used in supporting interactive editing of music and sound. The creation engine 208 is configured to help allow the user to create music and sound (e.g., muons, mosaics, sources). In some examples, the creation engine 208 is a decomposition and synthesization engine to analyze a digital representation of a sound and identify an encoding of partial information of the sound in order to generate a muon (i.e., resultant), wherein the partial information is partial abstract data exclusive of sampling, voice to text, and/or metadata and corresponds to one or more patterns of the sound. The user engine 210 is configured for users to manage and update their accounts, settings, generated content, as well as their relationship with other accounts (e.g., social relation, collaborative relation, commercial relation). The analysis engine 212 is configured to analyze all data on the system (e.g., computing and/or tracking similarities, rankings, ratings, pricing, various predictions, etc.) to provide services such as intelligent and/or personalized search, recommendation, and social connections. The sale/trade/credit engine 214 is configured to support all financial, commercial, valuational activities (e.g., credit, equity, business, marketing, advertising) on the system.

Turning to FIG. 3, FIG. 3 is a simplified block diagram of a portion of a system 100 configured to enable the decomposition and synthesization of music and sound, in accordance with an embodiment of the present disclosure. As illustrated in FIG. 3, the creation engine 208 can include a muon creation engine 302, a mosaic creation engine 304, and a source creation engine 306. The creation engine 208 allows the user to upload and/or create sources, cut muons from sources, and glue muons into mosaics. More specifically, the creation engine 208 can use the muon creation engine 302 to cut muons from sources, use the mosaic creation engine 304 to glue muons into mosaics, and use the source creation engine 306 to upload and/or create sources. For example, the creation engine 208 can be configured as a decomposition and synthetization engine to analyze a digital representation of a sound and identify an encoding of partial information of the sound in order to generate a muon (i.e., the resultant), wherein the partial information is partial abstract data exclusive of sampling, voice to text, and/or metadata and corresponds to one or more patterns of the sound

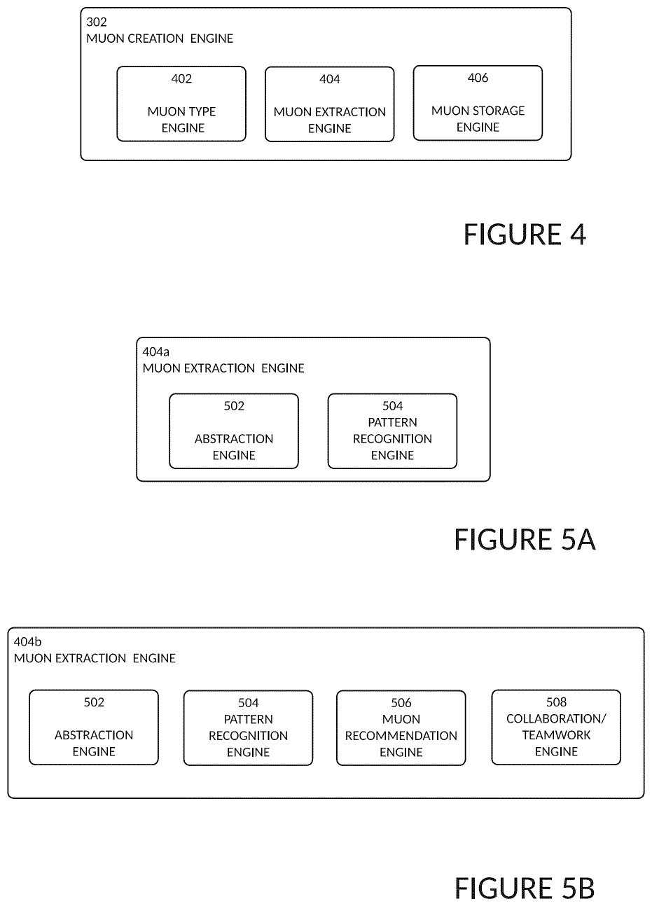

Turning to FIG. 4, FIG. 4 is a simplified block diagram of a portion of a system 100 configured to enable the decomposition and synthesization of music and sound, in accordance with an embodiment of the present disclosure. As illustrated in FIG. 4, the muon creation engine 302 can include a muon type engine 402, a muon extraction engine 404, and a muon storage engine 406. The muon creation engine 302 is an illustrative example of how a muon can be created. Changes, substitutions, variations, alterations, and modifications of the muon creation engine 302 may be ascertained to one skilled in the art and it is intended that the present disclosure encompass all such changes, substitutions, variations, alterations, and modifications as falling within the scope of the appended claims.

The muon type engine 402 is configured to determine and/or learn a type of muon to create. For example, the type of muon may be a harmony muon, a melody muon, a rhythm muon, an instrument muon, or some other type of muon. The type of muon can be determined by a specific request from a user for the specific type of muon or some other means. The muon extraction engine 404 is configured to extract muons from a source in a generalized sense by possibly including various abstractions. In many cases, a muon is an abstract extraction from a source and not a direct slice, sampling, or portion of the source. The muon storage engine 406 is configured to store created muons in the database in a way that further preserves data hierarchy, data relation, and data caches. In some examples, the muon storage engine 406 can be configured or customized for muon hierarchies (i.e., resultant hierarchies) and muon-based manipulations of sounds.

Turning to FIGS. 5A and 5B, FIGS. 5A and 5B are simplified block diagrams of a portion of a system 100 configured to enable the decomposition and synthesization of music and sound, in accordance with an embodiment of the present disclosure. As illustrated in FIGS. 5A and 5B, the muon extraction engine 404 can include two different embodiments 404a and 404b to support a single-user use case and a multi-user case (including other users that can be humans and/or AIs), respectively. Both embodiments can include an abstraction engine 502 that makes human-style abstractions and a pattern recognition engine 504 that performs pattern recognition in various abstraction spaces at all different abstraction levels (including the original raw space, often known as a Level-0 abstraction space).

As illustrated in FIG. 5B, the embodiment 404b of the muon extraction engine can further include a muon recommendation engine 506 that allows other users (including humans and AIs) to give recommendations to the current user and a collaboration/teamwork engine 508 that supports a teamwork infrastructure enabling various collaboration features (including without limitation, co-editing, commenting, providing feedback, text/video communications) in both synchronized and asynchronized settings.

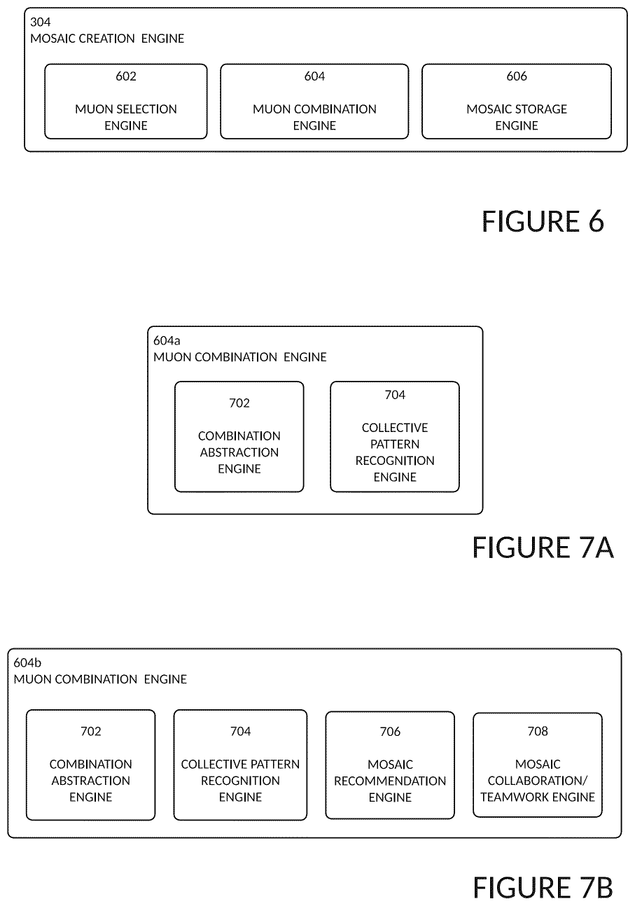

Turning to FIG. 6, FIG. 6 is a simplified block diagram of a portion of a system 100 configured to enable the decomposition and synthesization of music and sound, in accordance with an embodiment of the present disclosure. As illustrated in FIG. 6, the mosaic creation engine 304 can include a muon selection engine 602, a muon combination engine 604, and a mosaic storage engine 606. The mosaic creation engine 304 is an illustrative example of how two or more muons can be combined to create new mosaics. More specifically, one or muons can be used as a building block to be integrated into other sounds. Changes, substitutions, variations, alterations, and modifications of the mosaic creation engine 304 may be ascertained to one skilled in the art and it is intended that the present disclosure encompass all such changes, substitutions, variations, alterations, and modifications as falling within the scope of the appended claims.

The muon selection engine 602 is configured to specify a set of muons desired to be combined into a new mosaic (e.g., combining a melody muon from Song A and a harmony muon from Song B). The muon combination engine 604 is configured to synthesize the specified muons into a new mosaic done in a generalized sense by possibly including various abstractions. In many cases, a mosaic is an ensemble of literal and abstract syntheses instead of a literal sum of muons (e.g., just concatenation and/or layering). The mosaic storage engine 606 is configured to store created mosaic in the database in a way that further preserves data hierarchy, data relation, and data caches. In some examples, the mosaic storage engine 606 can be configured or customized for mosaic hierarchies and muon-based manipulations of sounds.

Turning to FIGS. 7A and 7B FIGS. 5A and 5B are simplified block diagrams of a portion of a system 100 configured to enable the decomposition and synthesization of music and sound, in accordance with an embodiment of the present disclosure. As illustrated in FIGS. 7A and 7B, the muon combination engine 604 can include two different embodiments 604a and 604b to support a single-user case and a multi-user case (including other users that can be humans and/or AIs), respectively. Both embodiments can include a combination abstraction engine 702 that makes human-style abstractions in the process of combining muons and a collective pattern recognition engine 704 that collectively recognizes multiple higher-level abstract patterns and synthesizes them into a lower-level pattern (such that the lower-level pattern matches the higher-level patterns when projecting onto the corresponding higher-level abstraction spaces). As illustrated in FIG. 7B, the embodiment 604b of the muon combination engine can further include a mosaic recommendation engine 706 that allows other users (including humans and AIs) to give recommendations about muon combination to the current user and a mosaic collaboration/teamwork engine 708 that supports a teamwork infrastructure enabling various collaboration features (including without limitation, co-editing, commenting, providing feedback, text/video communications) in both synchronized and asynchronized settings when combining muons.

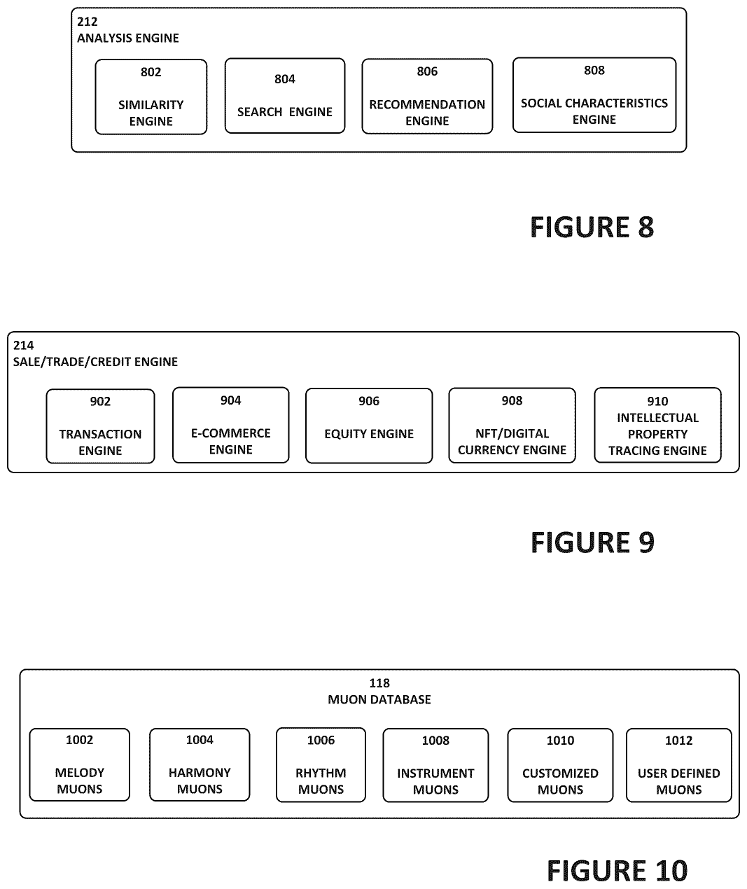

Turning to FIG. 8, FIG. 8 is a simplified block diagram of a portion of a system 100 configured to enable the decomposition and synthesization of music and sound, in accordance with an embodiment of the present disclosure. As illustrated in FIG. 8, the analysis engine 212 can include a similarity engine 802, a search engine 804, a recommendation engine 806, and a social characteristics engine 808. The similarity engine 802 determines similarities among data samples for various categories of data, which include without limitation, muon similarity, mosaic similarity, source similarity, user taste similarity, user talents/expertise similarity, etc. The search engine 804 can allow intelligent and/or personalized search as well as provide various types of rankings. Examples include, without limitation, ranking muons/mosaics/sources or other user-created content based on metrics such as similarity/rating/popularity/novelty, ranking users based on metrics such as productivity (number of muons/mosaics/sources or other content created) and popularity of their productions. In some examples, the search engine 804 is further used to build a ranking system, a recommendation system, an advertising system, or an intellectual property tracing system related to the resultant. In addition, the search engine 804 can be used to find other music/sounds with one or more similar muons. In some examples, the keymuon (described above) can be used as a search key in the search engine 804. The search engine 804 searches, ranks, recommends, muons by using similarities (e.g., pairwise similarities) computed by and/or stored in the similarity engine 802. The recommendation engine 806 can allow various types of intelligent and/or personalized recommendations. In many examples, a user can ask other users, AIs, or the system for recommendations. The social characteristics engine 808 can include many social media features and can further help facilitate building teams, collaborations, as well as various social and business relationships.

Turning to FIG. 9, FIG. 9 is a simplified block diagram of a portion of a system 100 configured to enable the decomposition and synthesization of music and sound, in accordance with an embodiment of the present disclosure. As illustrated in FIG. 9, the sale/trade/credit engine can include a transaction engine 902, an e-commerce engine 904, an equity engine 906, a music NFT/digital currency engine 908, and an intellectual property tracing system 910. The transaction engine 902 can be configured to help facilitate the selling and/or trading of muons. The e-commerce engine 904 can be configured to help facilitate the use of muons in e-commerce. The music NFT/digital currency engine 908 can help facilitate the use of muons as NFTs and/or digital currency. The intellectual property tracing system 910 can be used to help facilitate the use of muons in tracking and tracing intellectual property rights to sounds and music.

The transaction engine 902, the e-commerce engine 904, the equity engine 906, the music NFT/digital currency engine 908, and the intellectual property tracing system 910 can collectively support all financial, commercial, valuational activities (e.g., credit, equity, business, marketing, advertising) on the system. In some examples, a muon, a mosaic, a source, or other user-generated content can be a non-fungible token (NFT) and uploaded by the user. In some examples, the user can sell or trade muons, mosaics, sources, or other user-created content. The system can include all or at least a portion of the necessary functionalities to help facilitate such selling or trading. For example, the user can sell a muon, a mosaic, a source, or other user-created content. In some examples, a muon, a mosaic, a source, or other user-created content can be sold in the form of an NFT or as some form of music digital currency (e.g., a muon as a music building block can become a music version of “bitcoin”).

Turning to FIG. 10, FIG. 10 is a simplified block diagram of a portion of a system 100 configured to enable the decomposition and synthesization of music and sound, in accordance with an embodiment of the present disclosure. As illustrated in FIG. 10, the muon database 118 can include one or more melody muons 1002, one or more harmony muons 1004, one or more rhythm muons 1006, one or more instrument muons 1008, and/or other types of muons such as customized ones 1010 and user-defined ones 1012. Changes, substitutions, variations, alterations, and modifications of the muon database 118 may be ascertained to one skilled in the art and it is intended that the present disclosure encompass all such changes, substitutions, variations, alterations, and modifications as falling within the scope of the appended claims.

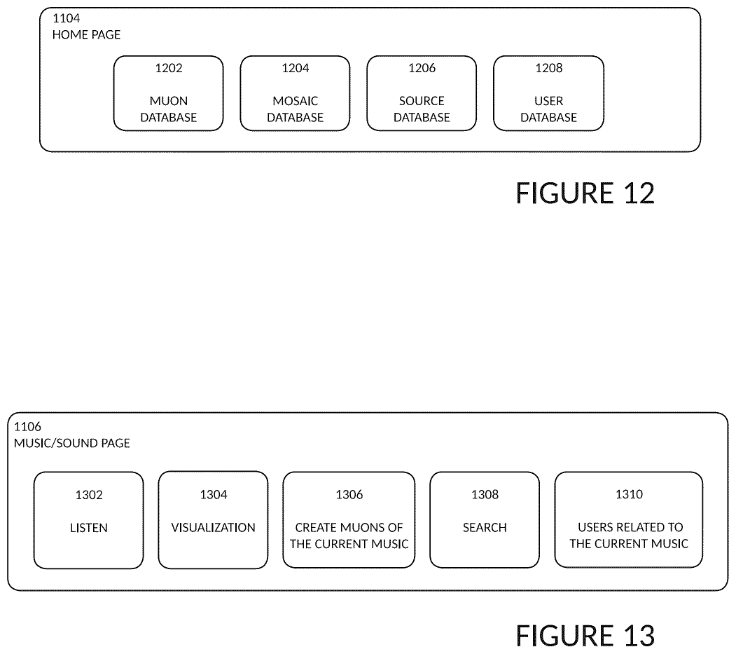

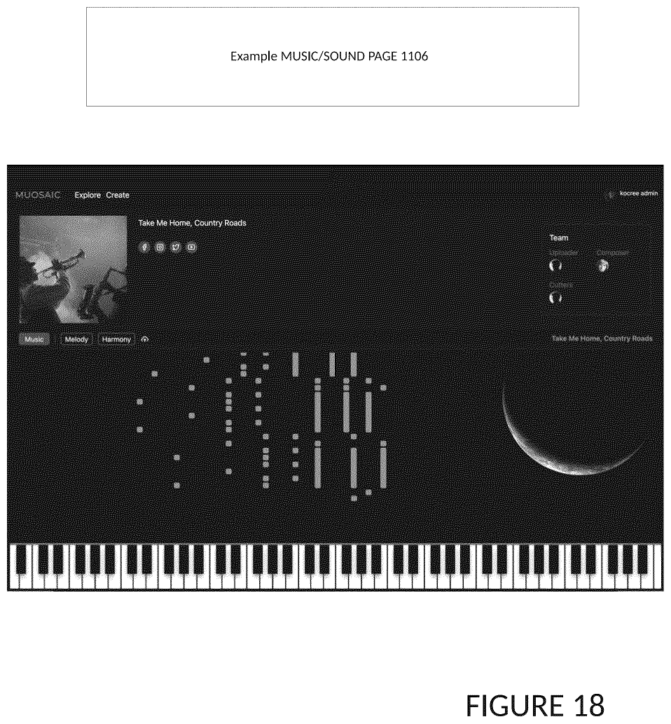

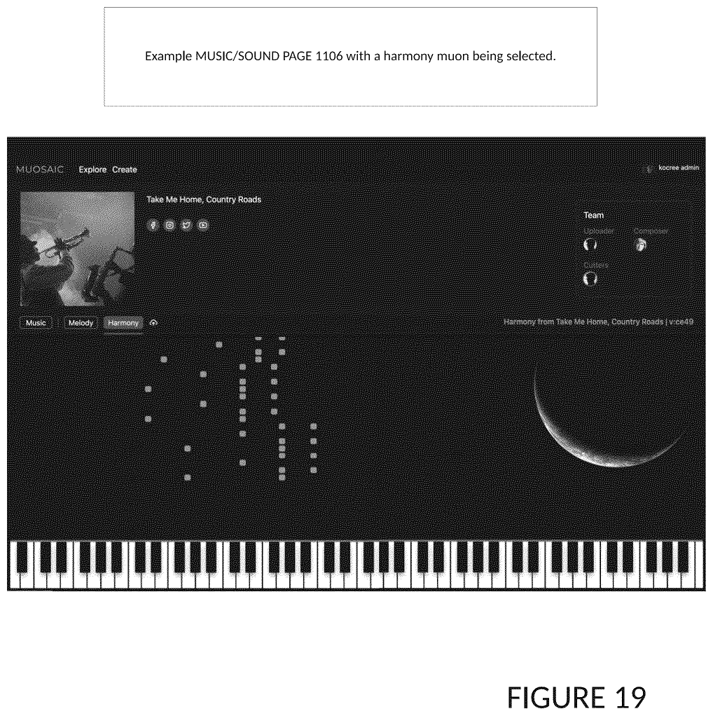

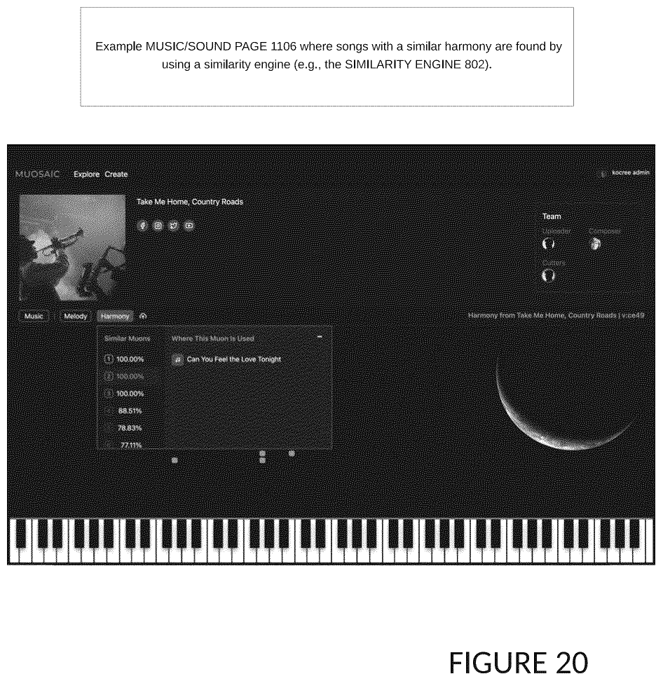

Turning to FIG. 11, FIG. 11 is a simplified block diagram of a portion of a system 100 configured to enable the decomposition and synthesization of music and sound, in accordance with an embodiment of the present disclosure. As illustrated in FIG. 11, several main pages can be displayed on the display 104, which includes a home page 1104, a music/sound page 1106, a user page 1108, an edit page 1110, a creation page 1112, and possibly a few other auxiliary pages. As illustrated in FIG. 12, a representative home page 1104 can include several selected portions (e.g., top rated, most viewed, most recent, etc.) of the muon database 1202, the mosaic database 1204, the source database 1206, and the user database 1208. In some examples, the home page 1104 can include other links, graphics, animations, or other visual representations and interactions. When a user selects a piece of music or sound on the home page 1104, the user is taken to that piece's music/sound page 1106 (several examples of the music/sound page 1106 are illustrated in FIGS. 18-20).

As illustrated in FIG. 13, a representative music/sound page 1106 is a main page for a user to listen 1302 and to visualize 1304 the selected music/sound, which can include a source, a mosaic, as well as muons of the selected music/sound. On the music/sound page 1106, a user can further create muons of the current music/sound 1306, run muon-based music/sound search and/or text search and/or searches in various other modalities 1308, and curate users who are related to the current music/sound 1310 (e.g., composers, cutters, gluers, uploaders). In some examples, the music/sound page 1106 can include other links, graphics, animations, or other visual representations and interactions.

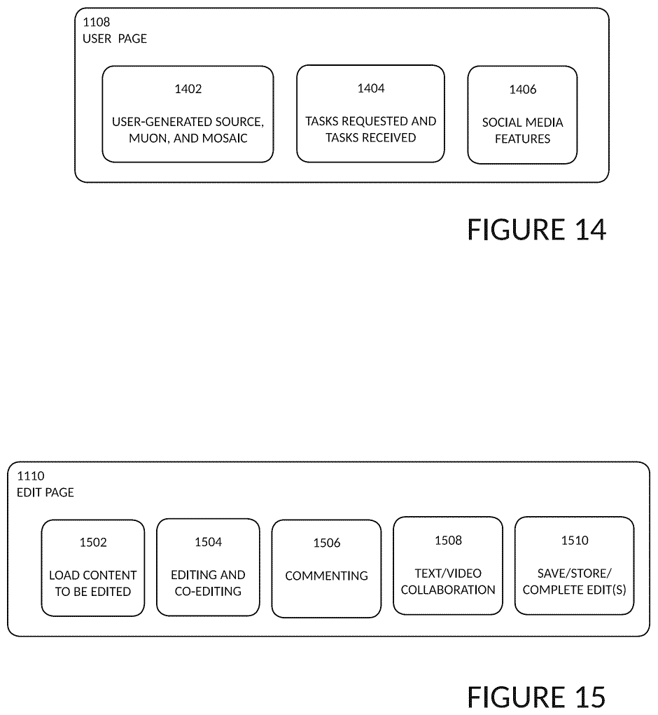

When a user selects a user profile image or username, the user is taken to the corresponding user's user page 1108. As illustrated in FIG. 14, a representative user page 1108 can include several exhibitions of user-generated and user-uploaded sources, muons, and mosaics 1402, tasks requested and tasks received 1404 from other users to join one or more collaborations, as well as several social media features 1406 (e.g., like, follow, friend, share, repost, etc.). The user page 1108 can be the current user's own profile page, or some other user's profile page. In some examples, the user page 1108 can include other links, graphics, animations, or other visual representations and interactions. In some examples, the user page 1108 can include a managing work and/or task tab in the user interface, and can show how many muons, mosaics, sources, tasks, and other materials each user has created. On the user page, the user can add art or some other image or visualization to a muon, mosaic, source, sound, or other content. The user can also upload a profile or avatar picture. In some examples, a visual of one or more muons, one or more mosaics, one or more sources, or other user created content can be included in the profile or avatar picture for the user.

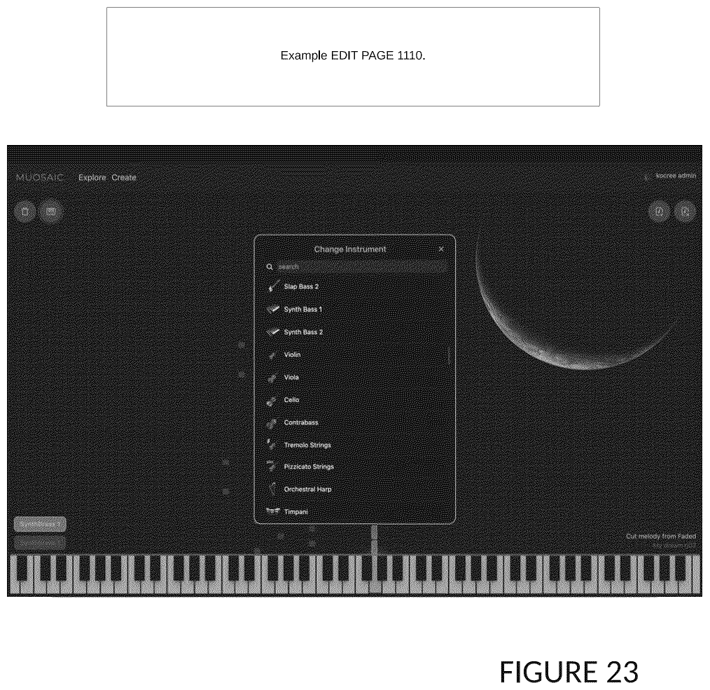

Whenever a user wants to create or edit music/sound (including muons, mosaics, sources) in the application, the user is taken to the edit page 1110. As illustrated in FIG. 15, a representative edit page 1110 can allow the user to load content to be edited 1502, edit and/or co-edit with other users 1504, make comments 1506, launch text/video collaborations 1508, and save/store/complete one or more edits 1510. In some examples, completing one or more edits can further yield the completion of one or more tasks. In some examples, the edit page 1110 can include other links, graphics, animations, or other visual representations and interactions. (An example edit page 1110 is illustrated in FIG. 23.)

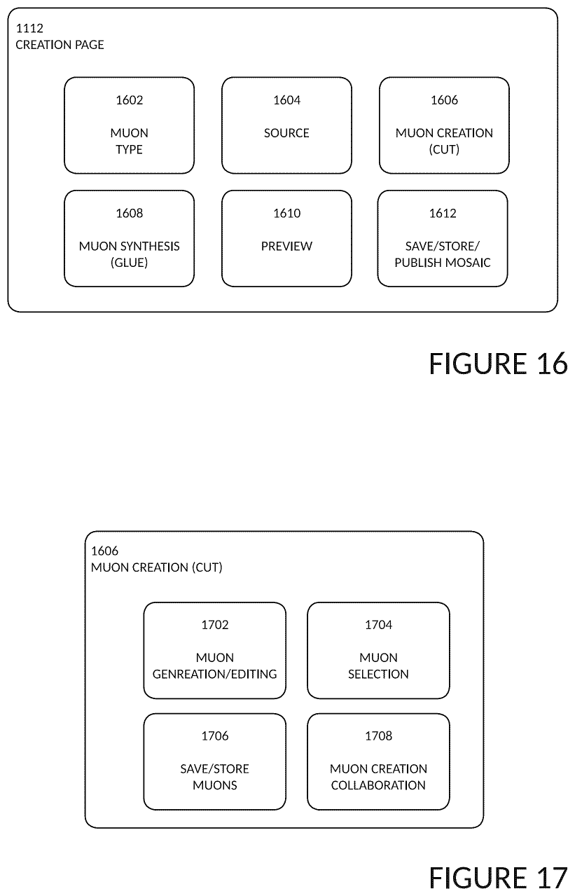

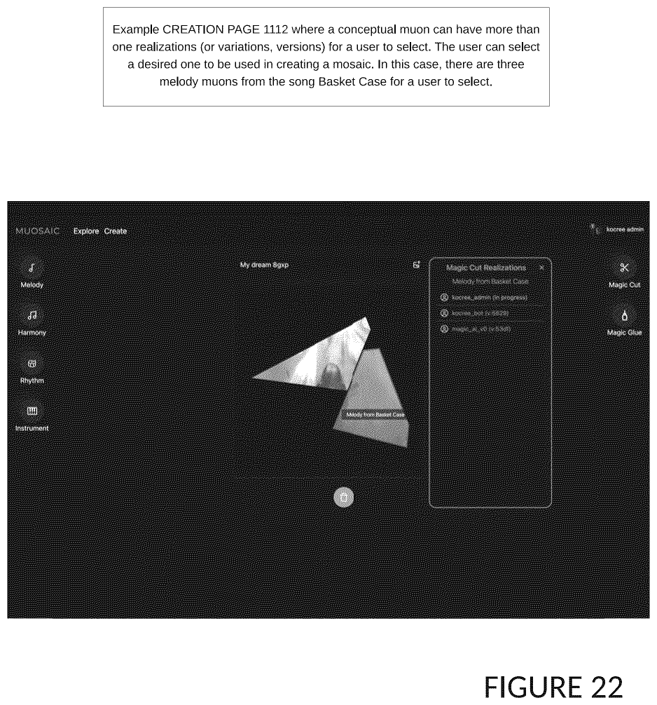

Turning to FIG. 16, FIG. 16 is a simplified block diagram of a portion of a system 100 configured to enable the decomposition and synthesization of music and sound, in accordance with an embodiment of the present disclosure. As illustrated in FIG. 16, the creation page 1112 can support features and functionalities, including without limitation, muon type specification 1602, source selection 1604, muon creation (cut) 1606, muon synthesis (glue) 1608, visual and aural preview 1610, and save/store/publish a mosaic. As further illustrated in FIG. 17, the muon create (cut) module can support muon generation and editing 1702 (e.g., through the edit page 1110), selecting muons from existing muon realizations 1704, save/store muons for muon synthesis 1706, and collaborative muon creation 1708. In some examples, muons, mosaics, sources, as well as their drafts, can be chosen from a dropdown menu or a ranked list, which can be further equipped with a search bar or a search box allowing fast exploration and curation. During muon/mosaic creation, the user can send requests/invitations to other users/AIs and invite them to join a collaboration. In some examples, invitees can be chosen from a dropdown menu or a ranked list, which can be further equipped with a search bar or a search box allowing fast exploration and curation. In some examples, the creation page 1112 can include other links, graphics, animations, or other visual representations and interactions. (Several examples of the creation page 1112 are illustrated in FIGS. 21-22). FIG. 22 illustrates several melodies from Basket Case that have been made and one that is in the process of being created or made. A user can select a specific melody muon to be combined with another sound (e.g., source, music, another muon, or some other sound) to create a mosaic.)

The application 1102 can have several self-contained functional modules. These can include an upload module used by the user to upload content (e.g., music/sound, images, videos, etc.) into the system. For example, the upload module can take the user to a pop-up modal that allows the user to select content stored on the user's device or content stored in a network element and store the content in the system's databases. The request-music module can be used by the user to request music from another user, an AI, or an outside source. For example, using the request-music module, the user can request specific music from other users or AIs. The requested music can then be received and stored in the system's databases. The request-collaboration module can be used by the user to request collaboration from another user or AI. For example, using the request-collaboration module, the user can send an invitation to other users and/or AI, asking them to join a collaboration. The respond-to-requests module can allow the user to respond to requests from other users. For example, another user may send the user a request for specific music/sound (e.g., muons, mosaics, sources) or collaboration. The user can use the respond-to-request module to respond to the request from the other user and provide the specific music/sound (e.g., muons, mosaics, sources) or collaboration to the other user.

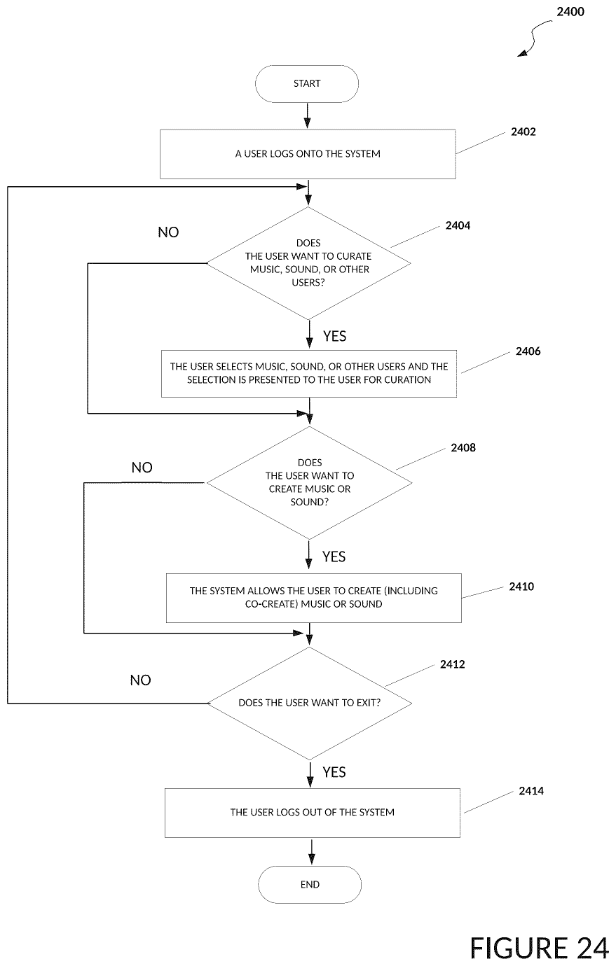

Turning to FIG. 24, FIG. 24 is an example flowchart illustrating possible operations of a flow 2400 (curation) that may be associated with enabling the decomposition and synthesization of music and sound, in accordance with an embodiment. In an embodiment, one or more operations of flow 2400 may be performed by the decomposition and synthesization engine 116 and network decomposition and synthesization engine 138 (including its sub-engines as illustrated in FIG. 2), as well as the muon database 118 and network muon database 140, the source database 120 and network source database 142, the mosaic database 122 and network mosaic database 144, the user database 124 and network user database 146, the cache database 126 and network cache database 148, and network AI-model database 150. At 2402, a user logs onto the system. At 2404, the system determines if the user wants to curate music, sound, or other users (including without limitation, human and AI users). If the answer is yes, the user selects music, sound, or other users and the selection is presented to the user for curation, as in 2406. In some examples, when the music/sound is played for the user, the system can display a visualization of the music/sound being played. If the user does not want to listen to, explore, or visualize a piece of music/sound, then the system determines if the user wants to create music/sound which includes without limitation, creating one or more muons and/or mosaics, as in 2408. If the answer is yes, in some examples, the user is taken to a creation page to create music/sound, as in 2410. If the user does not want to create any music or sound, then the system determines if the user wants to exit the system, as in 2412. If the user wants to exit the system, then the user is logged out of the system, as in 2414. If the user does not want to exit the system, then the system determines if the user wants to curate music, sound, or other users, as in 2404.

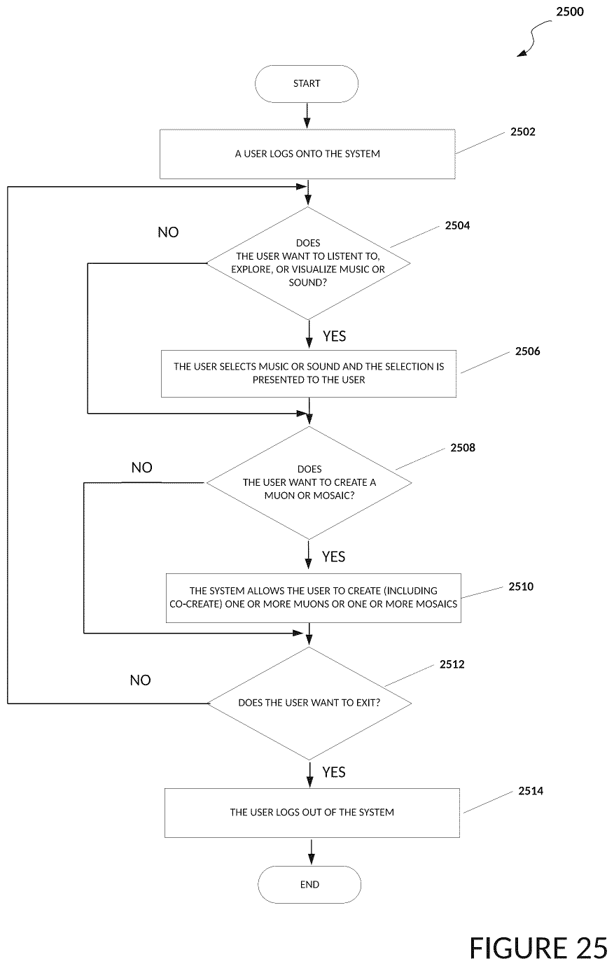

Turning to FIG. 25, FIG. 25 is an example flowchart illustrating possible operations of a flow 2500 (listening, exploration, and visualization) that may be associated with enabling the decomposition and synthesization of music and sound, in accordance with an embodiment. In an embodiment, one or more operations of flow 2500 may be performed by the decomposition and synthesization engine 116 and network decomposition and synthesization engine 138 (including its sub-engines as illustrated in FIG. 2), as well as the muon database 118 and network muon database 140, the source database 120 and network source database 142, the mosaic database 122 and network mosaic database 144, the user database 124 and network user database 146, the cache database 126 and network cache database 148, and network AI-model database 150. At 2502, a user logs onto the system. At 2504, the system determines if the user wants to listen to, explore, or visualize a piece of music/sound (e.g., a source or a mosaic together with its muons). If the answer is yes, the user selects a piece of music/sound and the selection is presented to the user, as in 2506. In some examples, when the music/sound is played for the user, the system can display a visualization of the music/sound being played. If the user does not want to listen to, explore, or visualize a piece of music/sound, then the system determines if the user wants to create music/sound which includes without limitation, creating one or more muons and/or mosaics, as in 2508. If the answer is yes, in some examples, the user is taken to a creation page to create music/sound, as in 2510. If the user does not want to create any music or sound, then the system determines if the user wants to exit the system, as in 2512. If the user wants to exit the system, then the user is logged out of the system, as in 2514. If the user does not want to exit the system, then the system determines if the user wants to listen to, explore, or visualize music/sound, as in 2504.

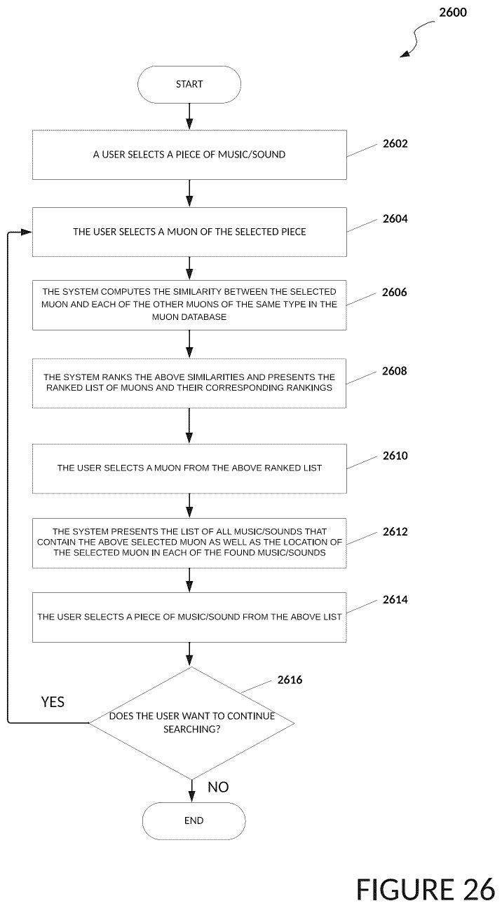

Turning to FIG. 26, FIG. 26 is an example flowchart illustrating possible operations of a flow 2600 (search) that may be associated with enabling the decomposition and synthesization of music and sound, in accordance with an embodiment. In an embodiment, one or more operations of flow 2600 may be performed by the decomposition and synthesization engine 116 and network decomposition and synthesization engine 138 (including its sub-engines as illustrated in FIG. 2), as well as the muon database 118 and network muon database 140, the source database 120 and network source database 142, the mosaic database 122 and network mosaic database 144, the user database 124 and network user database 146, the cache database 126 and network cache database 148, and network AI-model database 150. At 2602, a user selects a piece of music/sound from the system's databases. At 2604, the user further selects a muon of the selected piece of music/sound. At 2606, the system computes the similarity between the selected muon and every other muon of the same type in the muon database. For example, the similarity engine 802 can compute the similarity between the selected muon and every other muon of the same type in the muon database. At 2608, the system ranks the similarities and generates a ranked list of muons (e.g., from most similar muons to least similar ones) as well as their corresponding rankings. For example, the search engine 804 can rank the similarities and generate a ranked list of muons (e.g., from most similar muons to least similar ones) as well as their corresponding rankings. At 2610, the user selects a muon from the ranked list of muons. At 2612, the system finds the list of all music/sounds that contain the selected muon at 2610, as well as the location of the selected muon at 2610 in each of the found music/sounds. At 2614, the user selects a piece of music/sound from the list generated at 2612. At 2616, the system determines if the user wants to continue the search. If the answer is yes, the user further selects a muon of the most recently selected piece of music/sound, as in 2604. If the user does not want to continue the search, the search process is terminated.

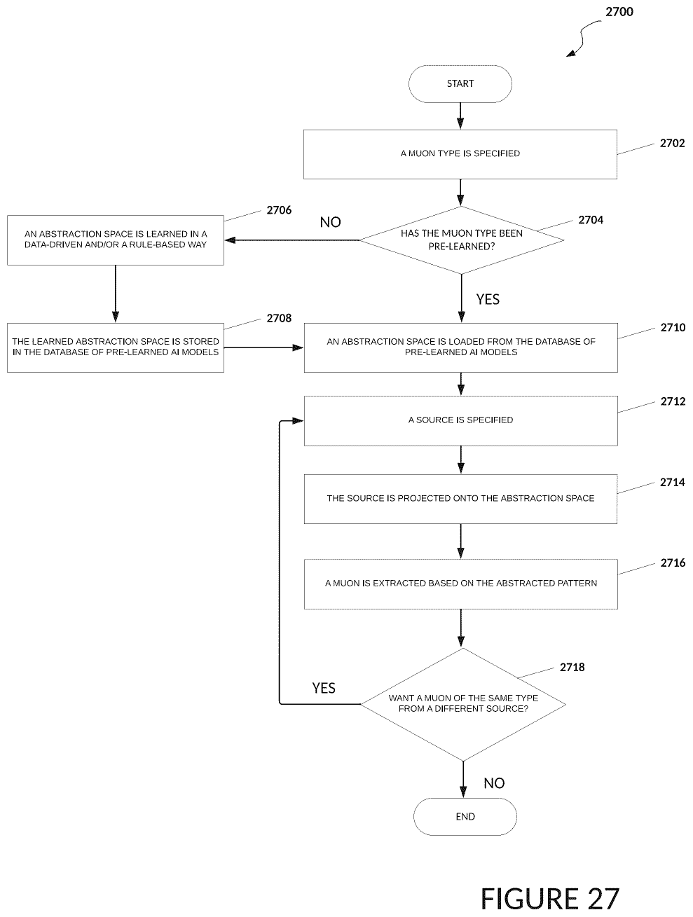

Turning to FIG. 27, FIG. 27 is an example flowchart illustrating possible operations of a flow 2700 (muon creation, or cut) that may be associated with enabling the decomposition and synthesization of music and sound, in accordance with an embodiment. In an embodiment, one or more operations of flow 2700 may be performed by the decomposition and synthesization engine 116 and network decomposition and synthesization engine 138 (including its sub-engines as illustrated in FIG. 2), as well as the muon database 118 and network muon database 140, the source database 120 and network source database 142, the mosaic database 122 and network mosaic database 144, the user database 124 and network user database 146, the cache database 126 and network cache database 148, and network AI-model database 150. At 2702, a user specifies a muon type. At 2704, the system determines if the specified muon type has been pre-learned by the system. If the answer is yes, at 2710, the system can load an abstraction space that corresponds to the specified muon type from the system's database of pre-learned AI models (e.g., a pre-learned lattice or a pre-learned neural network). If the specified muon type has not been pre-learned by the system, at 2706, the system can learn an abstraction space (e.g., in the form of an AI model such as a lattice or a neural network) corresponding to the specified muon type. This learning step can be done in a data-driven way, a rule-based way, a hybrid way, or some other way. Once an abstraction space has been learned, at 2708, the learned abstraction is stored in the database of pre-learned AI models. At 2710, the system can load this newly learned abstraction space from the database. After an abstraction space corresponding to the specified muon type is loaded, at 2712, a user further specifies a source. At 2714, the specified source is projected onto the abstraction space loaded at 2710. At 2716, a muon can be extracted based on the abstract pattern. At 2718, the system determines if the user wants another muon of the same type but from a different source. If the user wants another muon of the same type but from a different source, the user further specifies a source, as in 2712. If the user does not want another muon, the muon creation (cut) process is terminated.

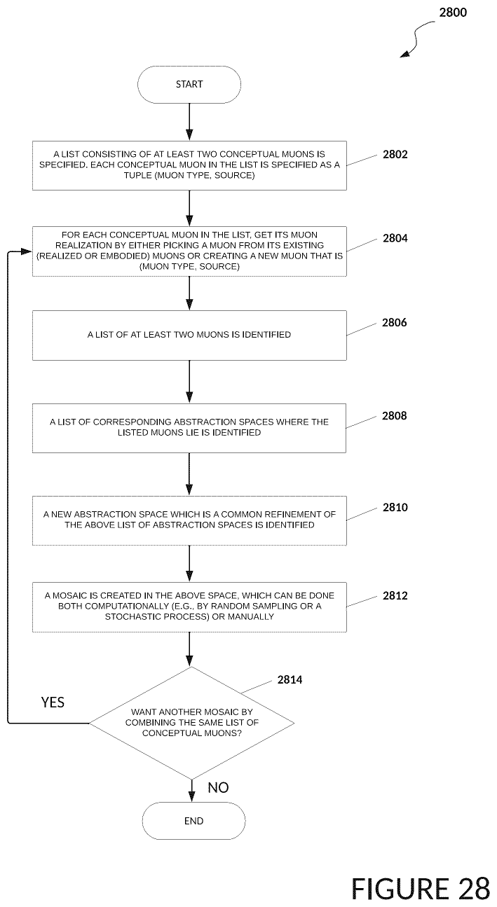

Turning to FIG. 28, FIG. 28 is an example flowchart illustrating possible operations of a flow 2800 (mosaic creation, or glue) that may be associated with enabling the decomposition and synthesization of music and sound, in accordance with an embodiment. In an embodiment, one or more operations of flow 2800 may be performed by the decomposition and synthesization engine 116 and network decomposition and synthesization engine 138 (including its sub-engines as illustrated in FIG. 2), as well as the muon database 118 and network muon database 140, the source database 120 and network source database 142, the mosaic database 122 and network mosaic database 144, the user database 124 and network user database 146, the cache database 126 and network cache database 148, and network AI-model database 150. At 2802, a user specifies a list consisting of at least two so-called “conceptual muons”. Unlike a (realized) muon which itself is a piece of music/sound that can be directly listened to and/or visualized, a conceptual muon is specified conceptually as a tuple (muon type, source). A conceptual muon can be thought of as a “name” of a muon, e.g., (melody, Song A) conceptually names a melody muon from Song A. At 2804, a user can get a realized muon (also called “muon realization”) for each conceptual muon in the list specified at 2802, by either picking a muon from the conceptual muon's existing muon realizations or creating a new muon that realizes the conceptual muon. At 2806, when the user finishes specifying a realization of every conceptual muon, a list of at least two muons is identified. At 2808, a list of corresponding abstraction spaces where the listed muons lie can be identified. At 2810, a new abstraction space which can be a common refinement of the list of abstraction spaces at 2808 can be identified. At 2812, a mosaic can be created in the new abstraction space identified at 2810. In some examples, creating a mosaic from an abstraction space can be done both computationally (e.g., by random sampling, a stochastic process, or a genetic algorithm) and manually (e.g., by manually sampling). At 2814, the system determines if the user wants another mosaic by combining the same list of conceptual muons. If the user wants another mosaic by combining the same list of conceptual muons, the user can specify a list of possibly different (or the same) muon realizations, as in 2804. If the user does not want another mosaic, the mosaic creation (glue) process is terminated.

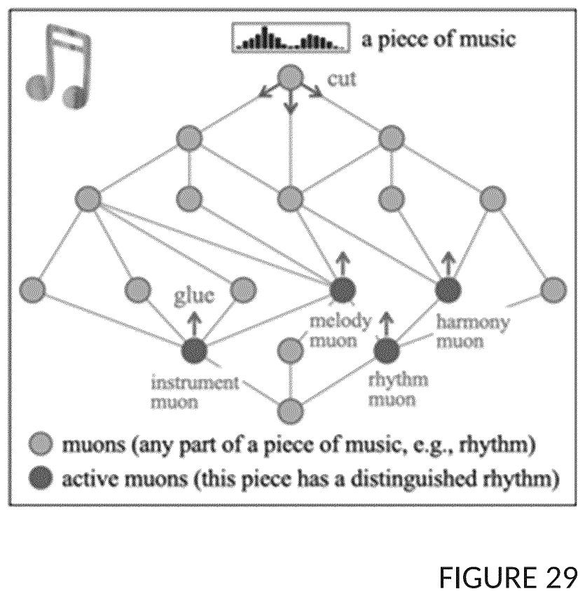

Turning to FIG. 29, FIG. 29 is a simplified block diagram of a portion of a system configured to enable the decomposition and synthesization of music and sound, in accordance with an embodiment of the present disclosure. As illustrated in FIG. 29, an example of an information lattice is shown, where every node can represent an abstraction space that can further correspond to a muon type (either with or without a known name). In some examples, a piece of music/sound can be injected to the information lattice from the top. Projecting this raw signal down onto some abstraction space can represent a cut operation, which can further yield a muon. Conversely, lifting several muons up to some abstraction space (e.g., an abstraction space that is a common refinement of the abstraction spaces the muons lie) can represent a glue operation, which can further yield a mosaic synthesizing the given muons.

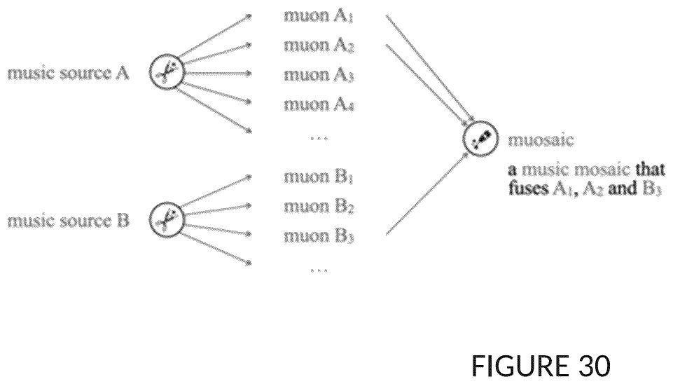

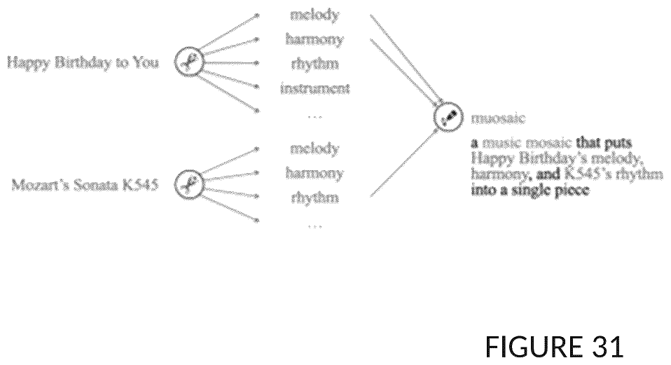

Turning to FIGS. 30-31, FIGS. 30-31 are two simplified block diagrams of a portion of a system configured to enable the decomposition and synthesization of music and sound, in accordance with an embodiment of the present disclosure. FIG. 30 illustrates an overview of the relationship among muons, mosaics, and sources: a source can be cut into one or more muons; two or more muons (possibly from one or more sources) can be glued into a mosaic. FIG. 31 further illustrates this relationship through a specific example. In this example, the “Happy Birthday to You” song and Mozart's Sonata K545 can be separately cut into various muons such as melody, harmony, and rhythm muons. A mosaic can be made by gluing a melody muon from “Happy Birthday to You”, a harmony muon from “Happy Birthday to You”, and a rhythm muon from Mozart's K545.

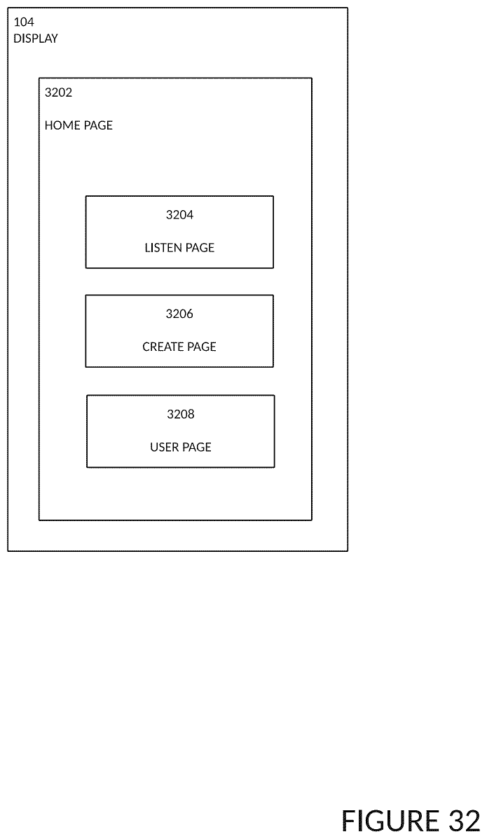

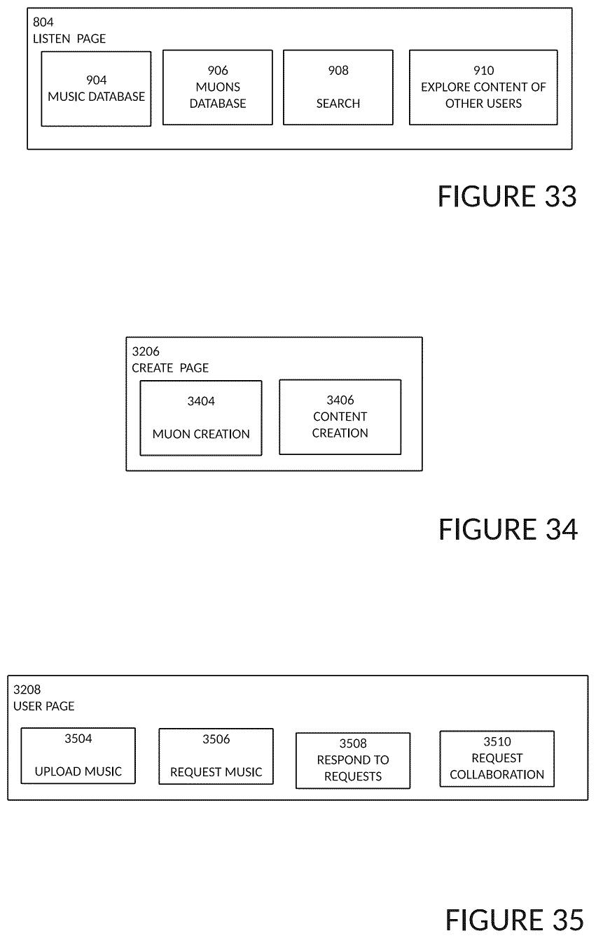

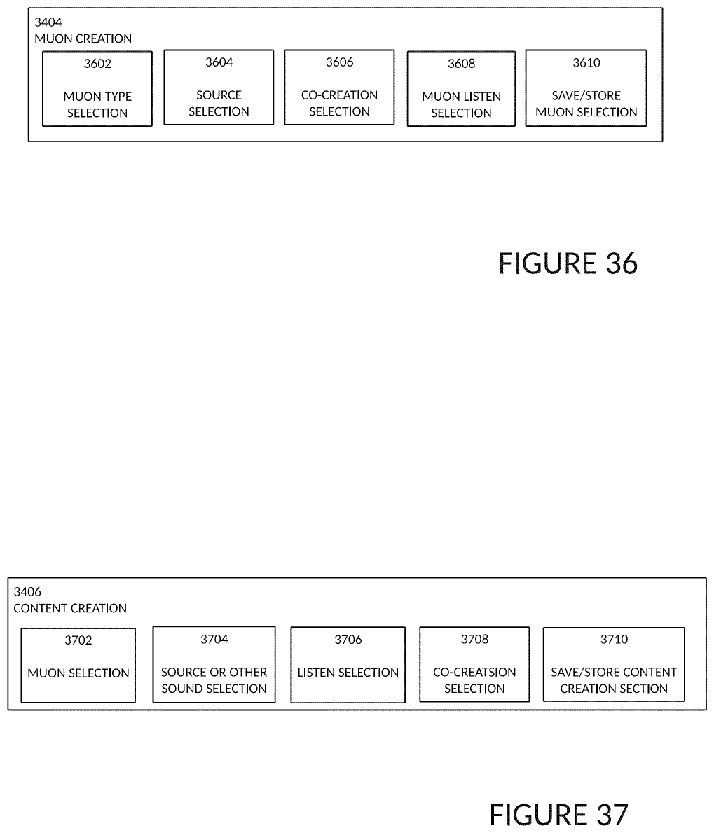

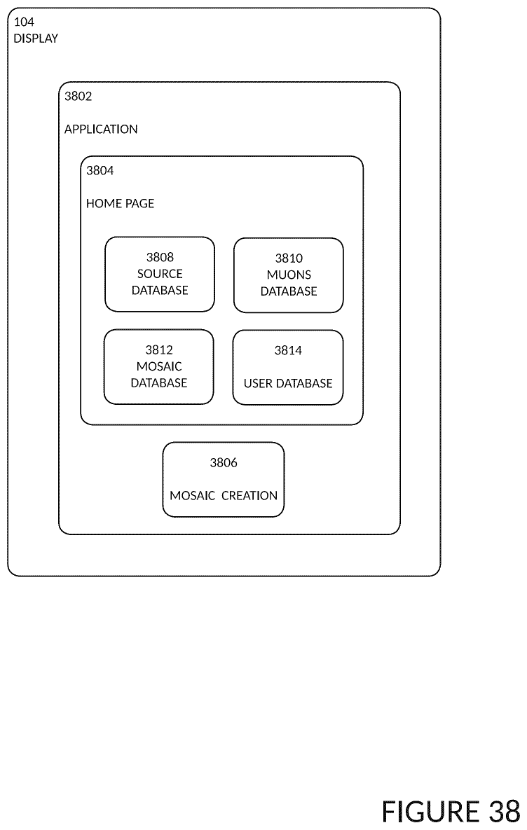

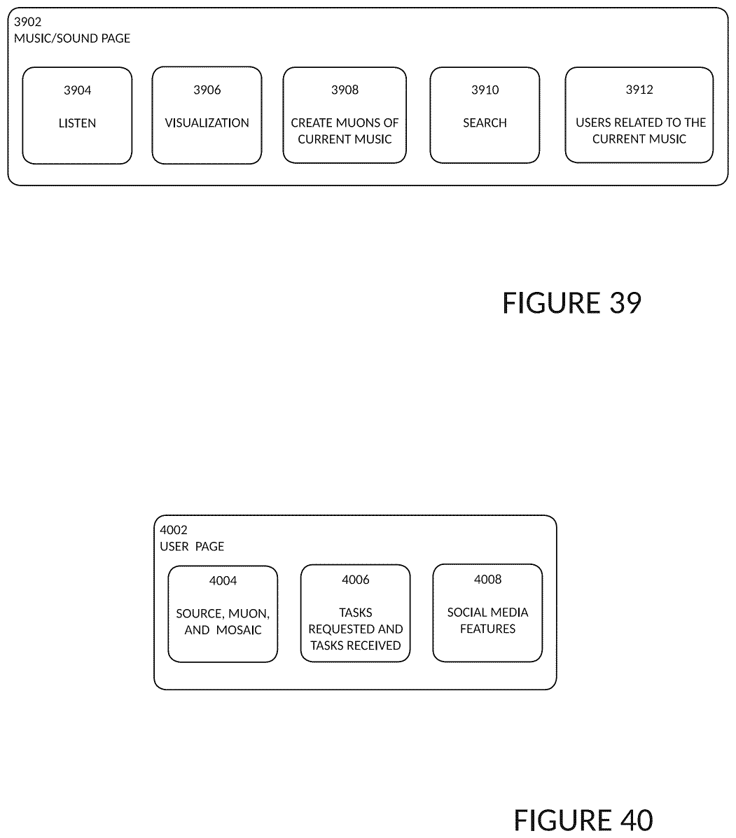

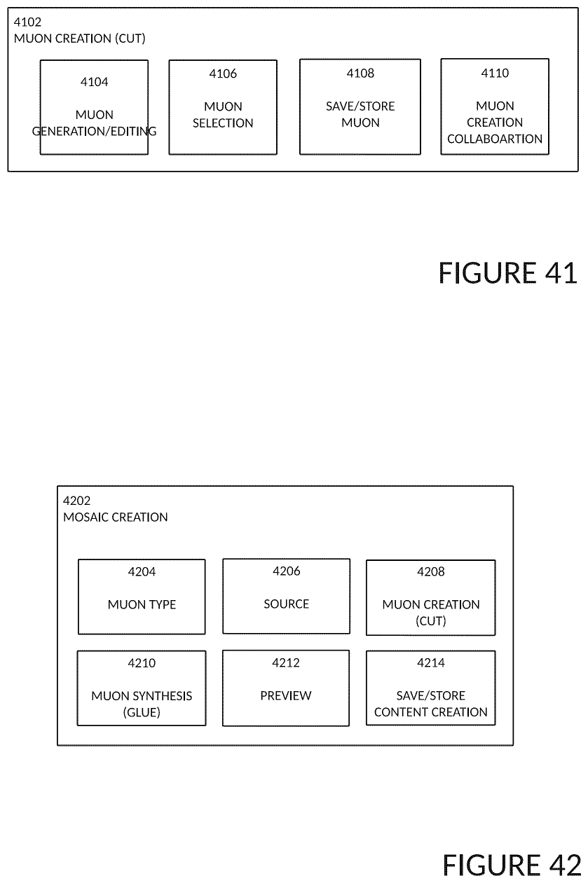

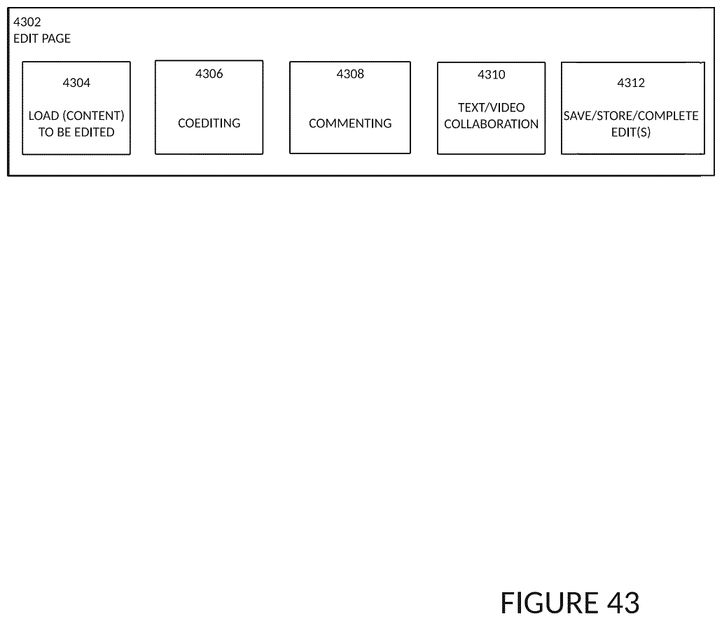

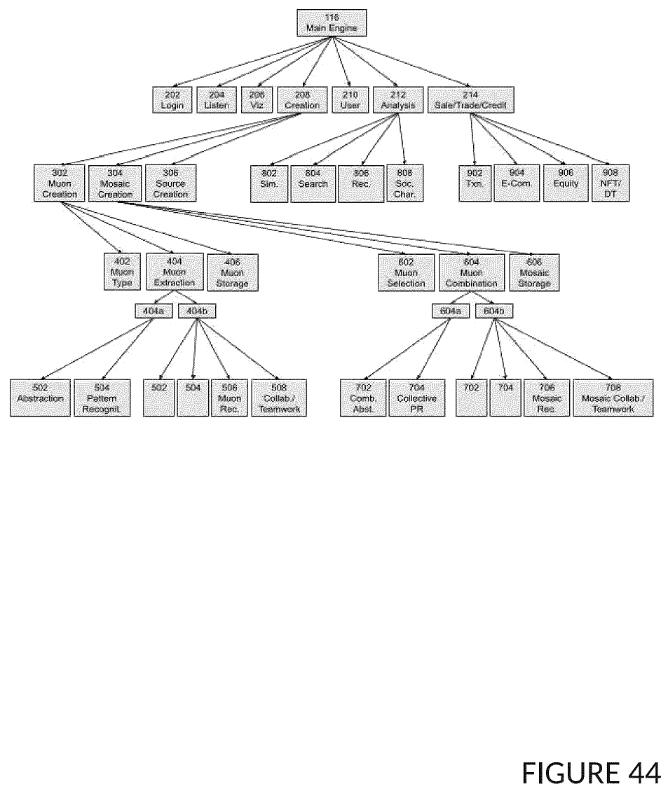

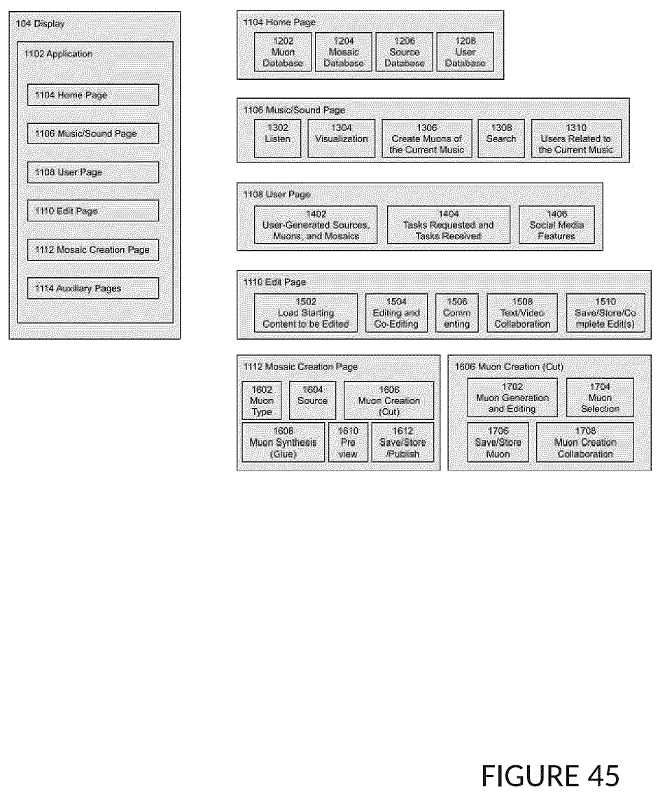

FIGS. 32-37 illustrate an example of a user interface that may be used to help the user interact with the system and to enable the decomposition and synthesization of music and sound. FIGS. 38-43 illustrate another example of a user interface that may be used to help the user interact with the system and to enable the decomposition and synthesization of music and sound. FIG. 44 illustrates an example relationship between user interfaces that may be used to help the user interact with the system and to enable the decomposition and synthesization of music and sound. FIG. 45 illustrates example pages, (e.g., of user interfaces, application, webpages, etc.) that may be used to help the user interact with the system and to enable the decomposition and synthesization of music and sound. Note that the example user interfaces and pages are for illustration purposes only and are non-limiting. Other user interfaces and pages than those illustrated and/or described herein may be used to help the user interact with the system and to enable the decomposition and synthesization of music and sound.

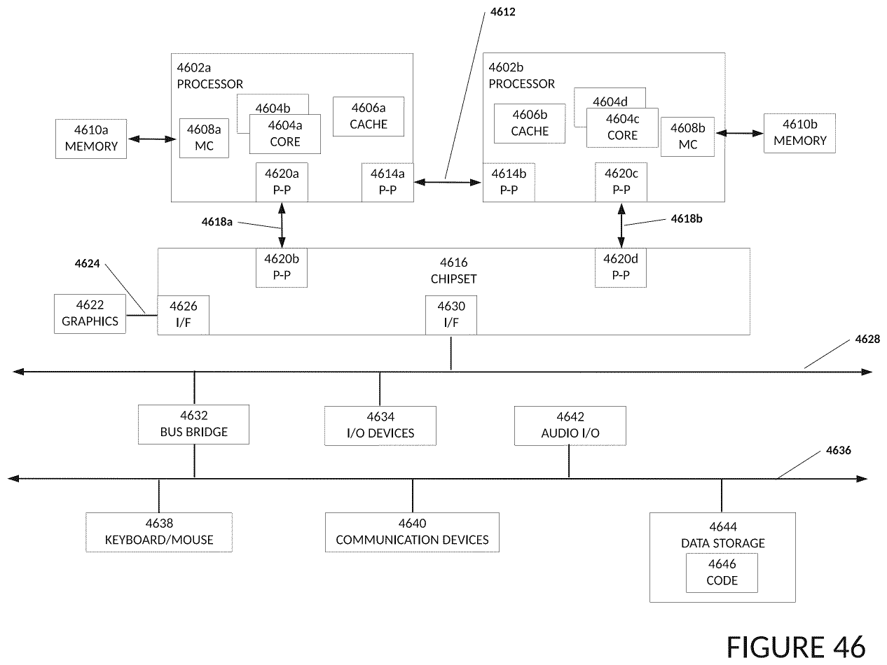

Turning to FIG. 46, FIG. 46 illustrates a computing system 4600 that may be used by at least a portion of the system 100 and is arranged in a point-to-point (PtP) configuration according to an embodiment. In particular, FIG. 46 shows a system where processors, memory, and input/output devices are interconnected by a number of point-to-point interfaces. Generally, one or more of the network elements of system 100 may be configured in the same or similar manner as computing system 4600.

As illustrated in FIG. 46, system 4600 may include several processors, of which only two, processors 4602a and 4602b, are shown for clarity. While two processors 4602a and 4602b are shown, it is to be understood that an embodiment of system 4600 may also include only one such processor. Processors 4602a and 4602b may each include a set of cores (i.e., processors cores 4604a and 4604b and processors cores 4604c and 4604d) to execute multiple threads of a program. The cores may be configured to execute instruction code in a manner similar to that discussed above with reference to FIGS. 1-8. Each processor 4602a and 4602b may include at least one shared cache 4606a and 4606b respectively. Shared caches 4606a and 4606b may each store data (e.g., instructions) that are utilized by one or more components of processors 4602a and 4602b, such as processor cores 4604a and 4604b of processor 4602a and processor cores 4604c and 4604d of processor 4602b.

Processors 4602a and 4602b may also each include integrated memory controller logic (MC) 4608a and 4608b respectively to communicate with memory elements 4610a and 4610b. Memory elements 4610a and/or 4610b may store various data used by processors 4602a and 4602b. In alternative embodiments, memory controller logic 4608a and 4608b may be discreet logic separate from processors 4602a and 4602b.

Processors 4602a and 4602b may be any type of processor and may exchange data via a point-to-point (PtP) interface 4612 using point-to-point interface circuits 4614a and 4614b respectively. Processors 4602a and 4602b may each exchange data with a chipset 4616 via individual point-to-point interfaces 4618a and 4618b using point-to-point interface circuits 4620a-4620d. Chipset 4616 may also exchange data with a high-performance graphics circuit 4622 via a high-performance graphics interface 4624, using an interface circuit 4626, which could be a PtP interface circuit. In alternative embodiments, any or all of the PtP links illustrated in FIG. 46 could be implemented as a multi-drop bus rather than a PtP link.

Chipset 4616 may be in communication with a bus 4628 via an interface circuit 4630. Bus 4628 may have one or more devices that communicate over it, such as a bus bridge 4632 and I/O devices 4634. Via a bus 4636, bus bridge 4632 may be in communication with other devices such as a keyboard/mouse 4638 (or other input devices such as a touch screen, trackball, etc.), communication devices 4640 (such as modems, network interface devices, or other types of communication devices that may communicate through a network), audio I/O devices 4642, and/or a data storage device 4644. Data storage device 4644 may store code 4646, which may be executed by processors 4602a and/or 4602b. In alternative embodiments, any portions of the bus architectures could be implemented with one or more PtP links.

The computer system depicted in FIG. 46 is a schematic illustration of an embodiment of a computing system that may be utilized to implement various embodiments discussed herein. It will be appreciated that various components of the system depicted in FIG. 46 may be combined in a system-on-a-chip (SoC) architecture or in any other suitable configuration. For example, embodiments disclosed herein can be incorporated into systems including mobile devices such as smart cellular telephones, tablet computers, personal digital assistants, portable gaming devices, etc. It will be appreciated that these mobile devices may be provided with SoC architectures in at least some embodiments.

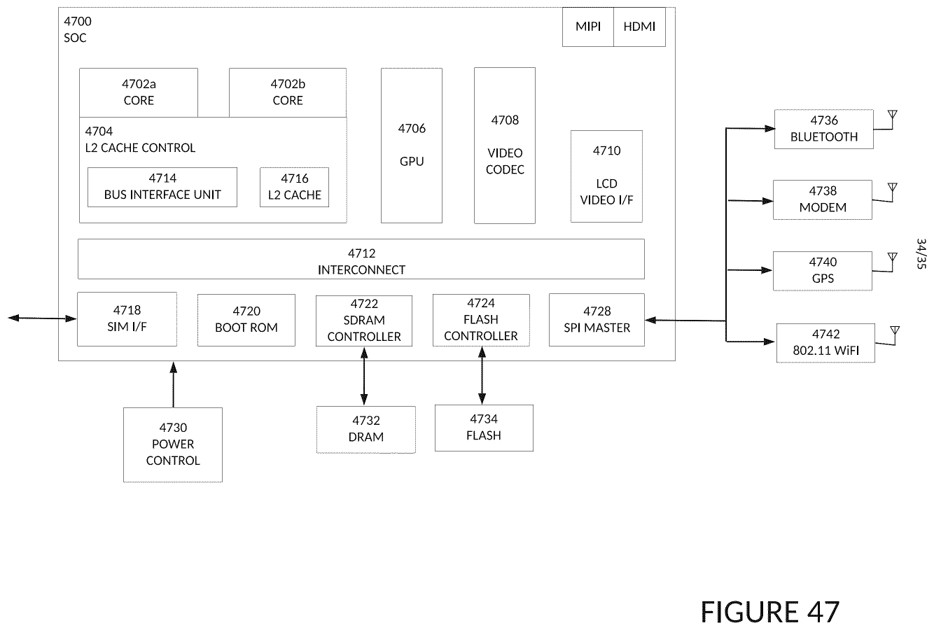

Turning to FIG. 47, FIG. 47 is a simplified block diagram associated with an example ecosystem SOC 4700 that may be utilized by the system 100 to implement various embodiments of the present disclosure. At least one example implementation of the present disclosure can include the decomposition and synthesization of music and sound features discussed herein and an ARM component. For example, the example of FIG. 47 can be associated with any ARM core (e.g., A-9, A-15, etc.). Further, the architecture can be part of any type of tablet, smartphone (inclusive of Android™ phones, iPhones™), iPad™, Google Nexus™, Microsoft Surface™, personal computer, server, video processing components, laptop computer (inclusive of any type of notebook), Ultrabook™ system, any type of touch-enabled input device, etc.

In this example of FIG. 47, ecosystem SOC 4700 may include multiple cores 4702a and 4702b, an L2 cache control 4704, a graphics processing unit (GPU) 4706, a video codec 4708, a liquid crystal display (LCD) I/F 4710 and an interconnect 4712. L2 cache control 4704 can include a bus interface unit 4714, a L2 cache 4716. Liquid crystal display (LCD) I/F 4710 may be associated with mobile industry processor interface (MIPI)/high-definition multimedia interface (HDMI) links that couple to an LCD.

Ecosystem SOC 4700 may also include a subscriber identity module (SIM) I/F 4718, a boot read-only memory (ROM) 4720, a synchronous dynamic random-access memory (SDRAM) controller 4722, a flash controller 4724, a serial peripheral interface (SPI) master 4728, a suitable power control 4730, a dynamic RAM (DRAM) 4732, and flash 4734. In addition, one or more embodiments include one or more communication capabilities, interfaces, and features such as instances of Bluetooth™ 4736, a 3G modem 4738, a global positioning system (GPS) 4740, and an 802.11 Wi-Fi 1042.

In operation, the example of FIG. 47 can offer processing capabilities, along with relatively low power consumption to enable computing of various types (e.g., mobile computing, high-end digital home, servers, wireless infrastructure, etc.). In addition, such an architecture can enable any number of software applications (e.g., Android™, Adobe® Flash® Player, Java Platform Standard Edition (Java SE), JavaFX, Linux, Microsoft Windows Embedded, Symbian and Ubuntu, etc.). In at least one example embodiment, the core processor may implement an out-of-order superscalar pipeline with a coupled low-latency level-2 cache.

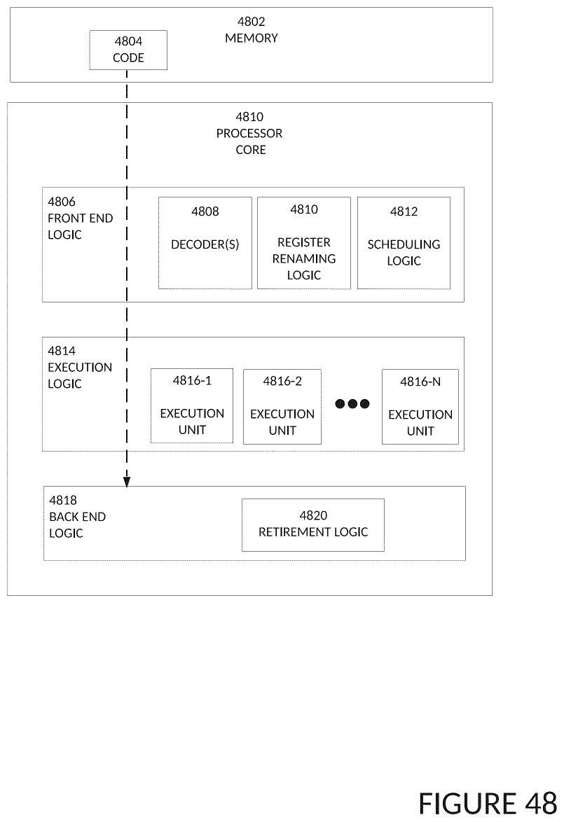

Turning to FIG. 48, FIG. 48 illustrates a processor core 4800 that may be part of one or more processors 108 and/or the system 100 according to an embodiment. Processor core 4800 may be the core for any type of processor, such as a micro-processor, an embedded processor, a digital signal processor (DSP), a network processor, or other device to execute code. Although only one processor core 4800 is illustrated in FIG. 48, a processor may alternatively include more than one of the processor core 4800 illustrated in FIG. 48. For example, processor core 4800 represents one example embodiment of processors cores 4604a-4604d shown and described with reference to processors 4602a and 4602b of FIG. 48. Processor core 4800 may be a single-threaded core or, for at least one embodiment, processor core 4800 may be multithreaded in that it may include more than one hardware thread context (or “logical processor”) per core.

FIG. 48 also illustrates a memory 4802 coupled to processor core 4800 in accordance with an embodiment. Memory 4802 may be any of a wide variety of memories (including various layers of memory hierarchy) as are known or otherwise available to those of skill in the art. Memory 4802 may include code 4804, which may be one or more instructions, to be executed by processor core 4800. Processor core 4800 can follow a program sequence of instructions indicated by code 4804. Each instruction enters a front-end logic 4806 and is processed by one or more decoders 4808. The decoder may generate, as its output, a micro-operation such as a fixed width micro-operation in a predefined format, or may generate other instructions, microinstructions, or control signals that reflect the original code instruction. Front-end logic 4806 also includes register renaming logic 3480 and scheduling logic 3462, which generally allocate resources and queue the operation corresponding to the instruction for execution.

Processor core 4800 can also include execution logic 3464 having a set of execution units 3486-1 through 3486-N. Some embodiments may include a number of execution units dedicated to specific functions or sets of functions. Other embodiments may include only one execution unit or one execution unit that can perform a particular function. Execution logic 3484 performs the operations specified by code instructions.

After completion of execution of the operations specified by the code instructions, back-end logic 3488 can retire the instructions of code 4804. In one embodiment, processor core 4800 allows out of order execution but requires in order retirement of instructions. Retirement logic 4820 may take a variety of known forms (e.g., re-order buffers or the like). In this manner, processor core 4800 is transformed during execution of code 4804, at least in terms of the output generated by the decoder, hardware registers and tables utilized by register renaming logic 3480, and any registers (not shown) modified by execution logic 3484.

Although not illustrated in FIG. 48, a processor may include other elements on a chip with processor core 4800, at least some of which were shown and described herein with reference to FIG. 48. For example, as shown in FIG. 48, a processor may include memory control logic along with processor core 4800. The processor may include I/O control logic and/or may include I/O control logic integrated with memory control logic.

It is important to note that the operations in the preceding flow diagram (i.e., FIGS. 26 and 27) illustrate only some of the possible correlating scenarios and patterns that may be executed by, or within, the system 100. Some of these operations may be deleted or removed where appropriate, or these operations may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by the system 100 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although the system 100 has been illustrated with reference to particular elements and operations, these elements and operations may be replaced by any suitable architecture, protocols, and/or processes that achieve the intended functionality of the system 100.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
analyzing a sound to identify an encoding of partial information of the sound in order to generate a resultant to be used in creating one or more manipulations associated with the sound, wherein the partial information is partial abstract data exclusive of sampling and corresponds to one or more patterns of the sound.

2. The method of claim 1, wherein the partial information is partial abstract data excluding voice to text and metadata.

3. The method of claim 1, wherein the sound is music including sheet music and other representations of music.

4. The method of claim 1, wherein the resultant is used as a search key in a search engine where results of the search include a plurality of resultants with similarities to the resultant.

5. The method of claim 4, wherein the search engine is further used to build a ranking system, a recommendation system, an advertising system, or an intellectual property tracing system related to the resultant.

6. The method of claim 4, wherein the search engine is used to find other sounds with similar resultants.

7. The method of claim 1, wherein the resultant is integrated into other sounds, wherein the resultant can be altered or combined with other resultants.

8. The method of claim 1, wherein the resultant is used as a building block in a gaming system or a composition system, wherein the resultant can be altered or combined with other resultants.

9. The method of claim 1, wherein the resultant is stored in a database customized for resultant hierarchies and resultant-based manipulations of sounds.

10. A system to identify an encoding of partial information of a sound in order to generate a resultant to be used in creating manipulations associated with the sound, the system comprising:
memory, wherein the memory includes a digital representation of the sound; and
a decomposition and synthetization engine to analyze the digital representation of the sound and identify an encoding of partial information of the sound in order to generate the resultant, wherein the partial information is partial abstract data exclusive of sampling and corresponds to one or more patterns of the sound.

11. The system of claim 10, wherein the resultant is generated using a computational abstraction framework to produce or create a collection of information lattices and sublattices encompassing learned abstraction patterns.

12. The system of claim 11, wherein the computational abstraction framework is Information Lattice Learning.

13. The system of claim 10, wherein the sound is music.

14. The system of claim 10, wherein a user defines and/or specifies one or more types of resultants to identify.

15. A device comprising:
memory for storing executable instructions;
a decomposition and synthetization engine; and
at least one processor to execute the instructions, wherein the decomposition and synthetization engine is configured to cause the at least one processor to:
create a digital representation of a sound from a sound source; and
analyze the digital representation of the sound to identify an encoding of partial information of the sound source in order to generate a resultant to be used in creating manipulations associated with the sound source, wherein the partial information is partial abstract data exclusive of sampling, voice to text, and metadata, and corresponds to one or more patterns of the sound source.

16. The device of claim 15, wherein the sound is music.

17. The device of claim 15, wherein the resultant is used as a search key in a search engine where results of the search include a plurality of resultants with similarities to the resultant.

18. The device of claim 17, wherein the search engine is used to find other sounds with similar resultants.

19. The device of claim 15, wherein the resultant is used as a building block to be integrated into other sounds.

20. The device of claim 15, wherein the resultant is stored in a database customized for resultant hierarchies and resultant-based manipulations of sounds.
